(19) United States
(12) Patent Application Publication
(10) Pub. No.: US 2019/0065684 A1
(43) Pub. Date: Feb. 28, 2019

(54) COMPUTER PROGRAM PRODUCTS, METHODS, AND SYSTEMS FOR ASSISTING A USER TO ACHIEVE A HEALTH-RELATED GOAL

(71) Applicant: FITMYLIFE HEALTH ANALYTICS INC., Edmonton (CA)

(72) Inventors: Geoff HAYWARD, Edmonton (CA); Nancy HERNANDEZ-CERON, Edmonton (CA); Jamil KABANI, Vancouver (CA)

(21) Appl. No.: 15/685,987

(22) Filed: Aug. 24, 2017

(51) Int. Cl. G06F 19/00; G06N 5/04; G06N 5/02

(52) U.S. Cl. CPC G06F 19/322; G06F 19/3437; G06F 19/3475; G06N 5/022; G06F 19/3481; G06N 5/04

(57) ABSTRACT

Computerized methods and systems for assisting a User to achieve a Health-Related Goal Set involves a processor periodically receiving Historical Data for the User or a group of Users similar to the User from one or more computing devices of the User or the group of Users via a communication network. The processor generates a Model that relates different Observables of the Historical Data, by optimizing fit of the Model to the Observables, and/or identifying a statistical correlation between the Observables. The processor evaluates at least one output based on the Model, and transmits the output to the computing device of the User via the communication network.

### FIELD OF THE INVENTION

The present invention relates to computer program products, methods, and systems for personal health management, and more particularly for assisting a user to achieve a health-related goal.

### BACKGROUND TO THE INVENTION

Many people seek new ways to manage their behavior to better realize specific health objectives. They are interested in modifying behavior patterns that they deem detrimental to their enjoyment of life. They want to better understand psychological factors that underlie repeated failures to change behavior. They are interested in better understanding mechanisms associated with certain biological and psychological processes that prevent them from reaching their health objectives.

For example, many are interested in overcoming issues with overeating. These issues have resulted in an obesity epidemic that spans the western world. Others want to build muscle through a resistance exercise training regime or improve endurance through a cardiovascular training regime. Others want to improve performance in a particular sport. Yet others are eager to change a pattern of addiction behavior.

In some cases, the factors that govern an individual's behavior are rooted in psychological processes. Understanding the root causes of destructive behavior patterns and ways to surmount them is critical to achieving personal change. In other cases, a better understanding of the mechanisms that drive biological processes such as metabolism, skeletal muscle growth, digestive issues, or the like is valuable to help an individual effectively modify his or her behavior. In this fashion, an individual's plans for preferred behavior should be rooted in a deep understanding of biological processes, psychological processes, and behavior patterns that may be unique to him. Further, the individual's plans for preferred behavior should be sensitive to factors that constrain the individual's behavior and limit the individual's options for change.

Computerized fitness tracking devices, calorie counting applications, and psychological profiling applications have become popular. Consequently, people have access to far more health data than they ever have had before. Many have access to detailed data regarding both the mechanics of their behavior (e.g., daily caloric intake, daily energy expenditure, sleep patterns, etc.). One might conjecture, that this data would help users modify detrimental behavior patterns. Unfortunately, studies often indicate that access to personal health data does not seem to be enough. These studies indicate that people are unable to take advantage of data about their behavior to initiate behavioral change. Data, in itself, is not enough.

A likely reason is that it is difficult to bridge the gap between raw data about daily activities (e.g., the number of steps taken in a day) and desired health objectives. In order to achieve important and persistent change, it is necessary to monitor digressions from optimal behavior, fully understand the negative consequences of these digressions, and identify ways to establish new patterns of behavior that supplant the old.

Many computerized systems are available to help individuals achieve their health Goals. Nevertheless, there remain significant challenges for software systems that model behavior, psychological, and biological processes.

A first challenge is that, mathematical models of processes (such as human energy metabolism, quotidian sleep cycles, or psychological motivation) are often generated through studies that impose highly artificial conditions. For instance, many metabolic studies begin with a multi-week period that provides controlled initial conditions for the study (e.g., ensuring an initial equilibrium exists in the macronutrient balance equations). Other studies prescribe a precise daily diet and activity schedule under controlled laboratory conditions. Similarly, sleep studies are usually performed in a laboratory setting that is intrinsically different from the environmental conditions that people confront in their own bedrooms. Models that are developed under such highly controlled conditions have limited value to explain behavior under the somewhat chaotic conditions of real life. Indeed, it may be that psychological and biological processes are governed by different rule sets when not operating under the externally controlled conditions of a laboratory study.

A second challenge with analytic models of biological and psychological processes is that there exist broad differences between how different individuals respond to given conditions. Typically, controlled studies succeed in predicting mean responses for a sample population. However, they often fail to predict the response for a given individual. There is substantial evidence that genetic variations between individuals are very broad indeed. These broad variances can lead to divergent responses to controlled stimuli.

A third challenge is that personal circumstances can constrain each individual in a multiplicity of ways. These constraints can generate unique circumstances for each individual. Even in the case of identical twins who, in principle, would exhibit identical mechanics of their biological processes, the constraints imposed by each of their lifestyles may be so different that it may not be practical to plan behavioral modification in the same way for both individuals. For instance, one individual may work day shifts, be sole caregiver for three children and have no support network. The other individual might work night shifts, have no dependents, and be primarily concerned about generating a social network that operates under the same unusual schedule as the individual does himself.

A fourth challenge is that, when attempting to identify a mechanistic model for a given biological process, there may or may not exist a single mathematical model that works for all. Consider, for instance, a model for human energy metabolism. People who are 50 years old and older are subject to a phenomenon known as sarcopenia, which is a natural degeneration of skeletal muscle tissue that accompanies the aging process. People who are 18 years and younger experience skeletal growth and the onset of puberty. Women of child bearing age experience menstrual cycles. When one focuses on the psychological processes that drive most behavior, the variability in models is, if anything, amplified. For some, behavior is driven primarily through self-efficacy, others through habit, others gravitate to opportunities for social engagement, while yet others are motivated by a desire to sustain a relationship with a loved one. In many cases, the motivators that drive behavior are unique to the individual. Correspondingly, a mechanistic model should include a term that accounts for the sarcopenia effect when modelling older individuals. Such a term should not appear in models that apply to younger individuals. Similarly, models for individuals 18 years and younger should incorporate mechanisms that account for skeletal growth and the onset of puberty. As a final example, models of metabolism for women of child bearing age should be sensitive to the menstrual cycle.

### SUMMARY OF THE INVENTION

There is a need in the art to assist users of computerized devices and applications to achieve their health-related Goals by bridging the gap between data generated by such devices and applications, and an understanding of individualized, real-world biological processes, physiological processes, and behavioral patterns of users.

This application relates to personal health management and technology. In particular, some embodiments of this invention relate to: acquisition of health data from devices and software applications, analysis of this data, generation of models that may be customized to emulate health-related processes for Users, generation of recommendations for optimal or preferred patterns of behavior for one or more Users to achieve health-related Goals, generation of predictive reports about the consequences of a multiplicity of distinct behavior patterns for one or more Users, and computer systems that automate the foregoing.

In one aspect, the present invention may comprise a method for assisting a User to achieve a Health-Related Goal Set, wherein the method is implemented by a processor operatively connected to the database and in communication via a communication network with a plurality of computing devices of the User and other Users. The method comprises periodically performing the steps of:
(a) receiving at the processor from one or more of the computing devices via the communication network, and storing and updating in the database, a record of Historical Data for the User or a group of the other Users deemed similar to the User by a filter function;
(b) generating a Model of one or more bodily or psychological processes relevant to the Goal Set of the User by one or a combination of:
   (i) performing a best fit optimization of an Analytic Model to Observables in the record of Historical Data, to determine values for the User of Customized Parameter(s) comprising coefficients of the Analytic Model, and thereby fully specifying the Analytic Model; and
   (ii) determining values of path coefficients of a Structural Equation Model (SEM) by determining values of correlation coefficients between linked Observables in the record of Historical Data, and thereby fully specifying the Structural Equation Model;
(c) evaluating at least one output based on the Model; and
(d) transmitting the output to the computing device of the User via the communication network.

In an embodiment of the method, the method further comprises selecting the Customized Parameter(s) to be determined from a Model Parameters Set based on at least one criterion comprising that the values of the Customized Parameter(s) for the group of Users have a variance that exceeds a threshold value.

In an embodiment of the method, the method further comprises selecting the Customized Parameter(s) to be determined from a Model Parameters Set based on at least one criterion comprising that the values of the Customized Parameter(s) for the User determined at different times have a variance that is less than a threshold value.

In embodiments of the method, generating the Model comprises performing the best fit optimization of the Analytic Model to Observables in the record of Historical Data, to determine values for the User of the Customized Parameter(s) comprising coefficients of the Analytic Model and thereby fully specifying the Analytic Model. Generating the Model may comprise selecting the Analytic Model from an Analytic Model Class based on data indicative of personal characteristics or constraints of the User. The Analytic Model may comprises a global function comprising the sum of a plurality of Analytic Models each of which is scaled by a Weighting Parameter associated with a different Goal within the Goal Set. Generating the Model may further comprise generating the Analytic Model from a preconfigured basis function. In an embodiment, generating the Analytic Model from the preconfigured basis function is based on at least one criterion comprising that the determined value of the Customized Parameter(s) for the preconfigured basis function maximizes an absolute value of a correlation coefficient of the Model to the Observables in the record of Historical Data.

In an embodiment of the method, generating the Model comprises determining values of path coefficients of a Structural Equation Model (SEM) by determining values of correlation coefficients between linked Observables in the record of Historical Data, and thereby fully specifying the Structural Equation Model.

In an embodiment of the method, the output comprises values of the Observables of the Historical Data predicted by the generated Model.

In an embodiment of the method, the output comprises a Plan selected automatically by another filter function from a Plan Repository stored in the database.

In an embodiment of the method, the output comprises a classification of one of the Observables in the record of Historical Data for the User as either beneficial or detrimental to the User achieving the Goal Set.

In another aspect, the present invention comprises a system for assisting a User to achieve a Health-Related Goal Set. The system comprises a processor operatively connected to a non-transitory computer readable memory, and a database, and in communication via a communication network with a plurality of computing devices of the User and other Users. The memory stores instructions executable by the processor to implement an embodiment of the method as described above.

In another aspect, the present invention comprises a non-transitory computer readable memory storing instructions executable by a processor to implement an embodiment of the method as described above.

### BRIEF DESCRIPTION OF THE DRAWINGS

In the drawings shown in the specification, like elements may be assigned like reference numerals. The drawings are not necessarily to scale, with the emphasis instead placed upon the principles of the present invention. Additionally, each of the embodiments depicted are but one of a number of possible arrangements utilizing the fundamental concepts of the present invention.

FIG. 1 illustrates an embodiment of the Onboarding Module of the HASS Application of the present invention acquiring personal data and constraints from the User, and a Remote Processing and Storage System of the present invention for processing User data and persistently storing User data on one or more data storage systems.

FIG. 2 illustrates the Onboarding Module of FIG. 1 interacting with health tracking devices and applications in an exemplary use of the present invention.

FIG. 3 illustrates the Onboarding Module of FIG. 1 managing a Goal Set for a User, including Metrics that will be used to assess progress and a Validation Schedule for evaluating that progress.

FIG. 4 illustrates the Onboarding Module of FIG. 1 ascribing Weighting Parameters to each of the Goals within the User's Goal Set to enable generation of a Composite Analytic Model along with a facility for multi-objective optimization for the entire Goal Set.

FIG. 5 illustrates the Onboarding Module of FIG. 1 selecting a Plan Set designed to optimize the probability of the User achieving the User's Goal Set from a Plan Repository and presenting it to the User.

FIG. 6 illustrates an embodiment of the Validation Module of the HASS application of the present application, along with a Testing Session interface, used to periodically assess the User's progress toward the User's Goals.

FIG. 7 illustrates an embodiment of the Data Acquisition Module and Data Translation Module of the HASS Application of the present invention, which are used to engage with registered devices and applications that share data with the HASS Application.

FIG. 8 illustrates an embodiment of the Data Cleansing Module of the HASS Application of the present invention, which is used to correct deficiencies with data entry.

FIG. 9 is a flow chart illustrating generation of an Analytic Model with its model parameters customized by historical data for the User or a group of Users deemed similar to the User by an automated filter function (e.g., having the same age, gender, matching body weight, and matching body fat percentage), by an embodiment of the Analytics Module of the HASS Application of the present invention.

FIG. 10 is a flow chart illustrating generation of an Analytic Model from a class of model and then customizing the preferred model with historical data for the User of a group of Users deemed similar to the User by an automated filter function, by another embodiment of the Analytics Module of the HASS Application of the present invention.

FIG. 11 is a flow chart illustrating generation of an Analytic Model through use of correlations and basis functions, by another embodiment of the Analytics Module of the HASS Application of the present invention.

FIG. 12 is a flow chart illustrating generating for the User: (a) a set of Structural

Equation Models that show causal linkages between behavior patterns and Goals set by the User; and (b) a set of behavior classifications, by another embodiment of the Analytics Module of the HASS Application of the present invention.

FIG. 13 is a flow chart illustrating generation of Pseudo-data from which it will generate a set of Structural Equation Models and behavior classifications, by another embodiment of the Analytics Module of the HASS Application of the present invention.

FIG. 14 is a flow chart illustrating generation of a Composite Analytic Model for several objectives, providing multi-objective optimization of behavior, and generating behavior classifications, by another embodiment of the Analytics Module of the HASS Application of the present invention.

FIG. 15 is a flow chart illustrating generation of prediction reports for the User and reports on Customized Observables that have been generated through best fit analysis with the historical data of the User or a group of Users deemed similar by an automated filter function, by another embodiment of the Analytics Module of the HASS Application of the present invention.

FIG. 16 illustrates an embodiment of the overall architecture for the HASS Application of the present invention with many component modules represented.

### DETAILED DESCRIPTION OF PREFERRED EMBODIMENT

Definitions. Any term or expression not expressly defined herein shall have its commonly accepted definition understood by a person skilled in the art. As used herein, the following terms have the following meanings.

“Processor”, “computer”, “computing device” and like terms refer to one or more electronic devices capable of performing operations on a data source. Non-limiting examples of processors and computers include devices commonly referred to as servers, general purpose computers, personal computers, desktop computers, laptop computers, handheld computers, tablets, telephones, mobile phones, smart phones, and the like. A processor or computer may comprise a single physical device, or multiple physical devices operatively connected to each other (e.g., a network of computers).

“Computer readable medium” or “CRM” refers to a non-transitory, tangible medium capable of encoding information in a format readable by a processor or computer. Non-limiting examples of CRM include magnetic media (e.g., a magnetic diskette or tape), optical media (e.g., an optical disc), and solid-state media (e.g., flash memory).

“Health Analytic Software System” or “HASS” is used for convenience to refer to an embodiment of a system of the present invention. “User” means a user of the HASS Application.

“Health-Related” means relating to a biological, physiological, chemical, or psychological process, or behavior of a User.

“Historical Data” means Health-Related data for a User that was acquired before a given point in time. “Pseudo-data” means Health-Related data for a User generated from a Model without the benefit of Historical Data. “Observable” means a particular type of Historical Data. “Direct Observable” means an Observable that that can be directly measured for a User. “Latent Observable” means an Observable that is implied by a set of indicator relationships. “Customized Observable” means an Observable that may be generated from a set of Customized Parameters. “Statistically Relevant Observable” or “SRO” mean an Observable (Direct, Latent, and/or Customized) that is selected as relevant to a Statistical Model.

“Goal” means a Health-Related Goal of a User. “Metric” means one or more types of Historical Data used to assess or monitor progress of a User toward a Goal or a Goal Set. “Testing Session” means an interactive session through which a User's progress toward a Goal is assessed. “Validation Schedule” means the schedule over which progress toward a Goal for a given User is assessed. For instance, a Goal may be assessed with a two-week periodicity.

“Plan” means a prescription for or prohibition from an activity ((e.g., dietary activity, resistance exercise activity, and cardiovascular exercise activity) for a User. “Plan Repository” means a collection of plans from which the HASS Application selects automatically Plans preferred for a given User. A “Plan Set” means a group of plans that have been selected automatically by the HASS Application as preferred for a given User using filter functions that are sensitive to the User's Goal Set and historical data. “Filter Functions” means a set of rules (which may be used hierarchically) for selecting a set of Users similar to a given User (e.g., same age, gender, comparable body weight, comparable body fat percentage), or a Plan Set for a User based on information associated with that User.

“Model” means an Analytic or Statistical Model designed to represent one or more bodily or psychological processes that are relevant to a User's Goal Set. “Model Class” means a genre of Models comprising different Models applicable to different subsets of a sample population of Users. For instance, it may be necessary to use distinct Model Classes to model sarcopenia for an aged population, skeletal muscle growth for an immature population, or unique metabolic properties associated with pregnant women.

“Model Parameter” means a parameter that is required to define a Model. “Fixed Parameter” means a Model Parameter that has a variance that is less than a pre-determined threshold amongst a population of Users. “Variable Parameter” means a Model Parameter that has a variance that is greater than or equal to a pre-determined threshold amongst a population of Users. “Customized Parameter” means a Model Parameter that has been selected for best fit optimization of a Model to Historical Data for a User. “Variance” means the value of the statistical variance of an Observable within Historical Data for a User or group of Users.

“Analytic Model” means a Model that is expressed in the form of one or more mathematical functions. “Composite Analytic Model” means a sum of multiple Analytic Models, with each constituent Model weighted by a scaling factor identified with a Weighting Parameter specified by the User or specified by pre-configured Weighting Parameters of the HASS Application. “Weighting Parameters” means a set of parameters that represent the relative priority of different Goals within a Goal Set.

“Statistical Model” means a Model that is expressed in the form of covariance relationships between Observables. “Structural Equation Model” or “SEM” means a Statistical Model that identifies correlations and/or causal connections between Observables, along with the magnitudes of the correlations and/or causal connections.

“Behavior Classifications” means behavior patterns identified by analyzing correlations between Historical Data indicative of a User's behaviors and a Goal Set of the User. Behaviors Classifications may be either beneficial or detrimental to a User achieving a Goal Set. “Time To Live” or “TTL” means a time threshold through which Behavior Classifications or other classifications are deemed as valid, and after which the classification is deemed invalid.

“Predictive Report” means an assessment of how an aspect of a User's Health-Related condition (e.g., body composition, sleep efficiency, or a psychological variable) will evolve according to a Model.

“Set” means a collection of one or more items of a distinct type.

Overview of HASS Application. This invention relates to an automated computer system, that helps people understand both mechanisms that govern biological processes (such as metabolism, the skeletal muscular system, the neurological system, sleep patterns, and the like) while also understanding psychological motivations and the underlying factors that trigger certain behavior patterns.

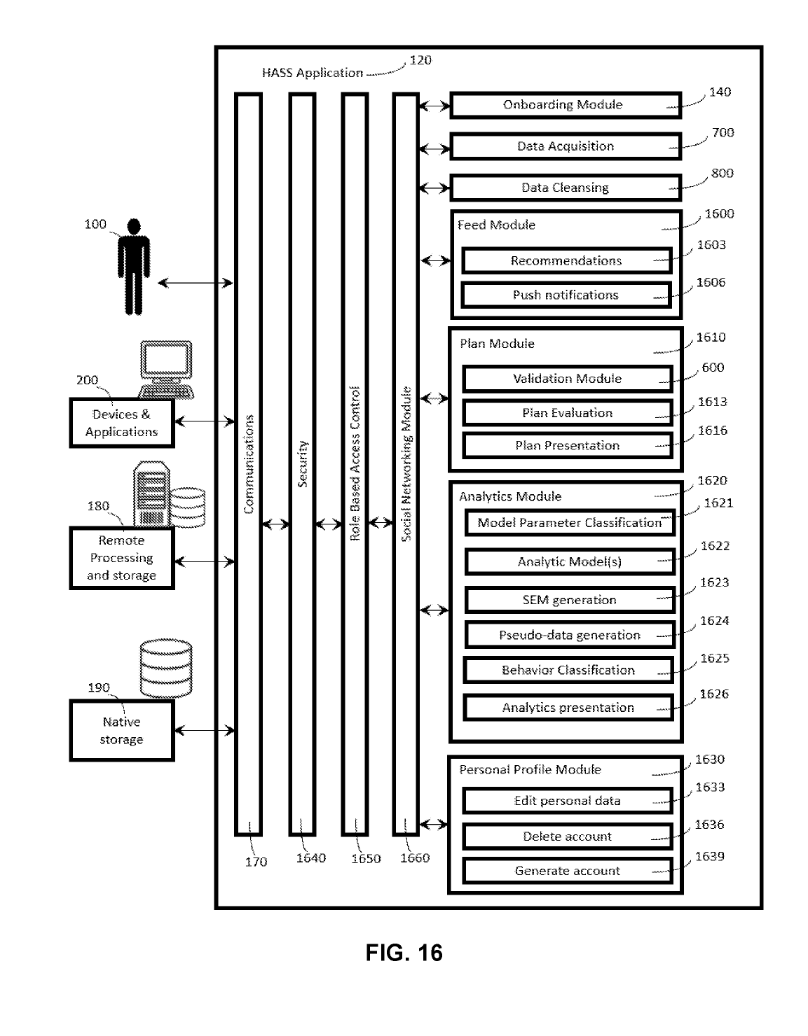

FIG. 16 illustrates components of an embodiment of the HASS Application, 120. The User, 100, one or more Remote Processing and Storage Systems, 180, a series of registered computer devices and applications, 200, used by the User along with native storages, 190, of the registered devices, all engage with the HASS Application through the Communications Module, 170. The HASS Application may be stored on a non-transitory computer readable medium in a memory device of the Remote Processing and Storage System, 180, for execution by a computer processor of the Remote Processing and Storage System, 180.

The Communications Module, 170, enables communication between the Remote Processing and Storage System, the devices and application, 200, and their native storage devices, 190, via a communications network. The Security Module, 1640, handles encryption, decryption, authentication, authorization, and additional security features associated with data exchange between the device and applications, 200, and the HASS Application, 120. The Role Based Access Control Module, 1650, handles sharing permissions for registered professionals and other Users with whom sharing is enabled via the Social Networking Module, 1660.

The Onboarding Module, 140, is responsible for identity management, log in, sign up, lost password retrieval, acquisition of personal data and personal constraints, acquisition of Goals within the Goal Set, Metrics, Validation Schedules, Weighting Parameters, and initial generation and presentation of the Plan Set to the User.

The Data Acquisition Module, 700, is responsible for interfacing the Remote Processing and Storage Systems, 180, with registered devices and applications, 200, via a communications network. In embodiments, the communications network may comprise one or a combination of the Internet, a telephone network, and other networks enabling communication between computing devices.

Data Translation Module, 760, may be necessary for use with certain devices and applications, 200, so that properties that have a special definition within a given device or application may be represented with a definition that is common to all devices and applications, 200.

The Data Cleansing Module, 800, is used to correct failures to enter data (whether they be caused by failure of the User to enter data or failure to acquire data through one or more registered devices or applications, 200).

The Feed Module, 1600, presents timely recommendations, push notifications, personal records, and social networking news to the User.

The Plan Module, 1610, includes a Validation Module, 600, and Testing Session Module, 610, that helps the User assess progress towards the Goal Set. It also may include a Plan Evaluation Module, 1613, for periodically updating plans as the User's Historical Data changes. Finally, it includes a Plan Presentation Module, 1616, that the User or registered professionals with sharing privileges can use to generate custom plans.

The Analytics Module, 1620, may include a number of components. These may include the Model Parameter Classification Module, 1621, a Module for generation of one or more Analytic Models, 1622, a Module for generation and presentation of one or more SEMs, 1623, a Module for generation of Pseudo-data, 1624, and an Analytics Presentation Module, 1626.

A Personal Profile Module, 1630, is used to periodically update personal data as the User's situation changes, 1633, delete accounts, 1636, and generate accounts, 1629.

The following discussion describes in greater detail embodiments of some of the aforementioned modules and the processes performed by them.

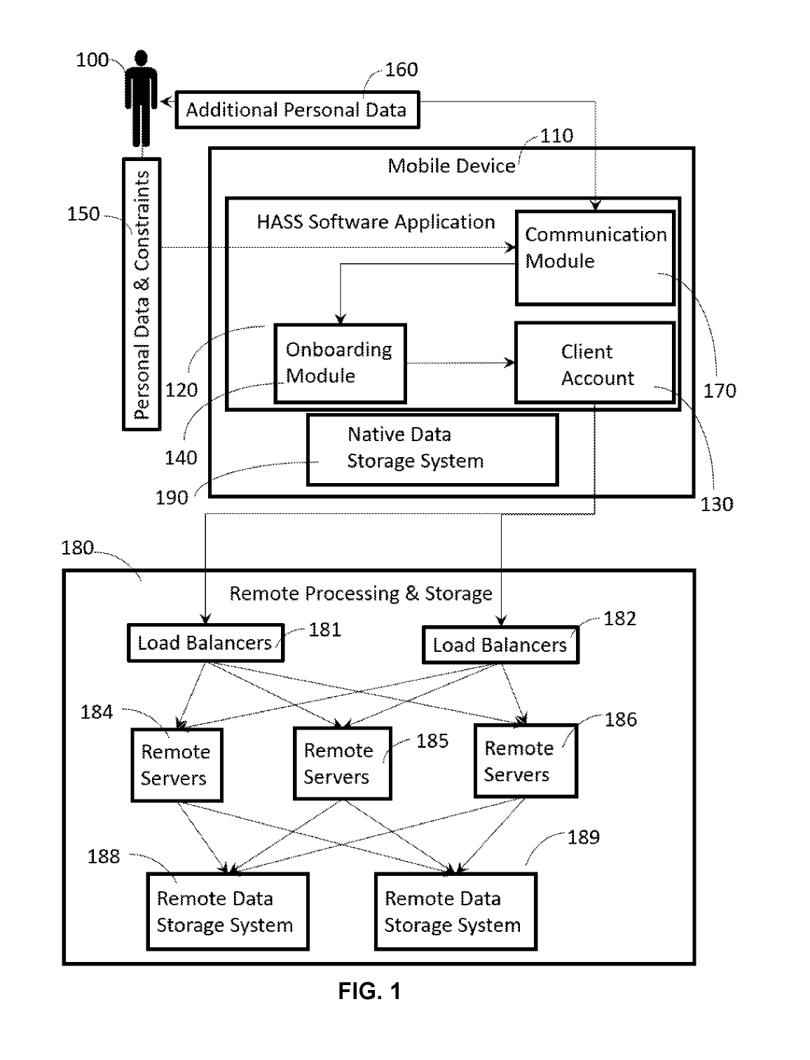

Onboarding Module: User Registration. FIG. 1 illustrates the User registration process managed by the Onboarding Module, 140, by which a new User 100 initially engages with the HASS Application, 120. The User may register through the medium of a mobile device, 110, such as a mobile phone. However, registration may also proceed through a personal computer, tablet, or other digital computer devices, such as a watch, MP3 player, or the like. Upon registration, the User must generate a unique, secure User account, 130. The User may leverage credentials from some other supported software application (e.g., Facebook™) or the User may generate new credentials for the User's HASS User account.

The User provides personal data, 150, as requested by an Onboarding Module. The personal data is used by the HASS Application to ascribe initial classifications to the User, with regard to the biological processes, psychological processes, and/or behavior patterns that the User wants to modify. For example, to initialize the analytic system for metabolism during the registration process, the User might provide data about: gender, age, height, body weight, body fat percentage, medical issues, medications, recent surgery, pregnancy, behavior patterns related to physical exercise, technical expertise with resistance exercise regimes and cardiovascular training regimes, along with other information that may be needed by the HASS Application.

In some cases, the HASS Application, 120, may acquire additional personal data, 160, after the onboarding process is complete. This may occur when a particular software module associated with a given process or behavior is engaged for the first time. It may also occur through an ongoing dialogue between the User and the HASS Application. Transfer of this additional information is mediated by a Communication Module, 170. This additional personal data may be modified by the User from time to time as necessary. The User may also provide additional data by responding to push notifications and/or recommendations generated automatically by the HASS Application and mediated by the Communication Module, 170.

The Onboarding Module, 140, may also request personal data relating to constraints that influence some aspect of the User's behavior. This transaction is mediated by the Communication Module, 170. A personal constraint occurs when the User has obligations that prevent him from modifying his/her behavior in some fashion. For instance, a User may not have the flexibility to go to a gym more than once or twice per week due to child care responsibilities. Similarly, a User may not be able to sleep during night time hours due to employment that involves night shift work.

As a result of the foregoing registration process, the User provides personal data and constraints that allow the HASS Application, 120, to generate an initial classification of the individual for modeling of a multiplicity of biological processes, psychological processes, and behavior patterns. These might include the metabolism, endocrine, renal, skeletal muscle, lymphatic, nervous, reproductive, respiratory, addiction behavior, sleep patterns, and other processes and behavior patterns of concern to the User.

The HASS Application, 120, processes and stores data in at least one Remote Processing and Storage System, 180. Each Remote Processing and Storage System may include one or more Load Balancers (181-182) for partitioning traffic between Remote Servers (184, 185, 186). After processing, data is stored on one or more Remote Data Storage Systems (188, 189). In addition, Load Balancers, Remote Servers, and Remote Data Storage Systems may employ high availability software and/or hardware systems to ensure continuous or near continuous availability of data to a multiplicity of Users. In addition, data storage systems may be in a multiplicity of locations remote from the user to provide protection from disaster or security breach scenarios.

Further, the HASS Application, 120, may store the personal data on a data storage system, 190, native to the computational device (e.g., mobile phone, personal computer, tablet, or some comparable device) used by the User for the engagement with the HASS Application, 120.

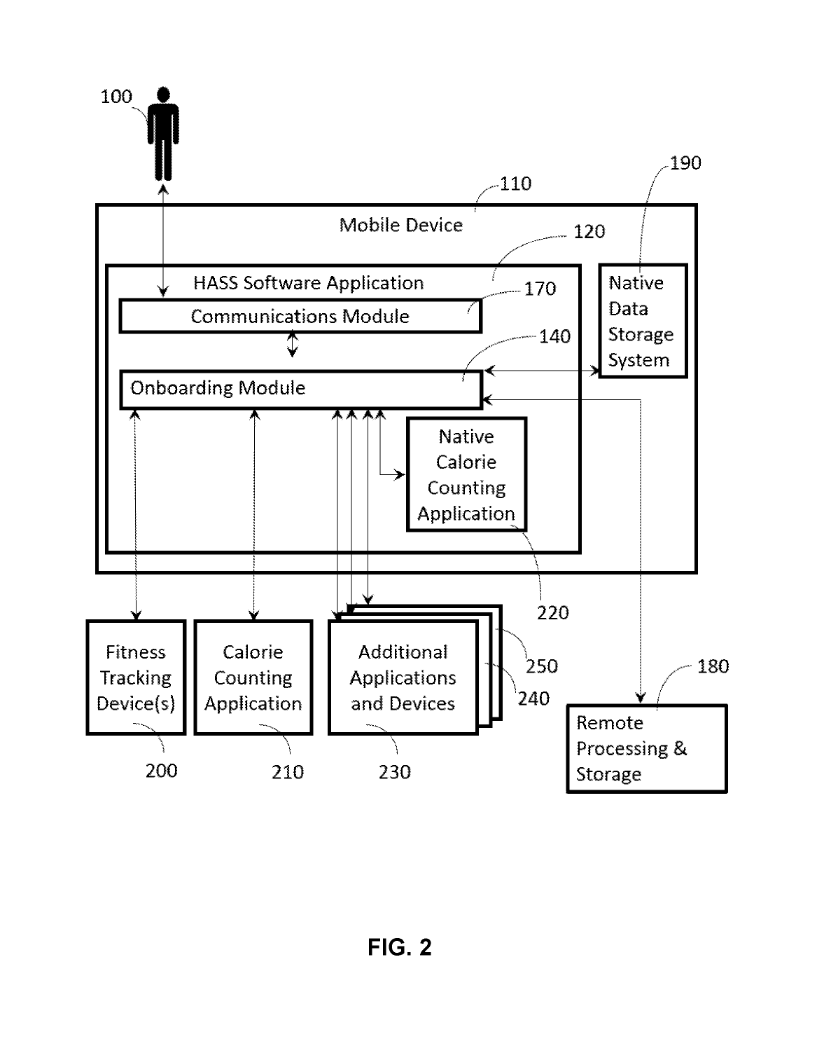

Onboarding Module: Device and Application Registration. FIG. 2 illustrates the device and application registration stage of the Onboarding managed by the Onboarding Module, 140. Once personal data and constraints have been registered, the Onboarding Module, 140, through the Communications Module, 170, may ask the User, 100, to register one or more computing device(s) and/or applications, 200, 210, and 230-250, from which to acquire Health-Related data. For example, one of the computing devices may be a fitness tracking device, 200. In addition, the Onboarding Module may ask the User, through the Communications Module, to register one or more Calorie Counting Application(s), 210, from which it will acquire automatically a record of food ingested, time of ingestion, a distribution of macronutrients, and a distribution of micronutrients. If the User does not already use a calorie counting application, the HASS Application may use its native Calorie Counting Application, 220.

The HASS Application may also request registration of other devices and software applications, 230, 240, 250, and so on. These devices may include applications or devices that detect body fat percentage, blood pressure, blood sugar, blood alcohol levels, skin temperature, sleep data, global positioning data, and other health and fitness data. The HASS Application, 120, validates that it can acquire data from each registered software application and tracking device through an appropriate Application Programming Interface (API).

In some cases, the HASS Application can auto-discover devices and applications whose data may already be shared with it (e.g., through Apple HealthKit™ or through Google Fit™). In such cases, the User is asked to select one or more preferred fitness tracking devices to register with the HASS Application, 120. In some cases, the User must provide credentials to the secure account associated with the registered devices and applications (200-250). Alternately, the User may need to enable application sharing before the HASS Application can acquire data automatically from the registered devices and applications (200-250).

The HASS Application stores information about registered software applications, tracking devices, and also data acquired from these sources on at least one Remote Processing and Storage System, 180. As before, it may also store this data on a native storage, 190, native to the computational device, 110, used to engage the HASS Application, 190120.

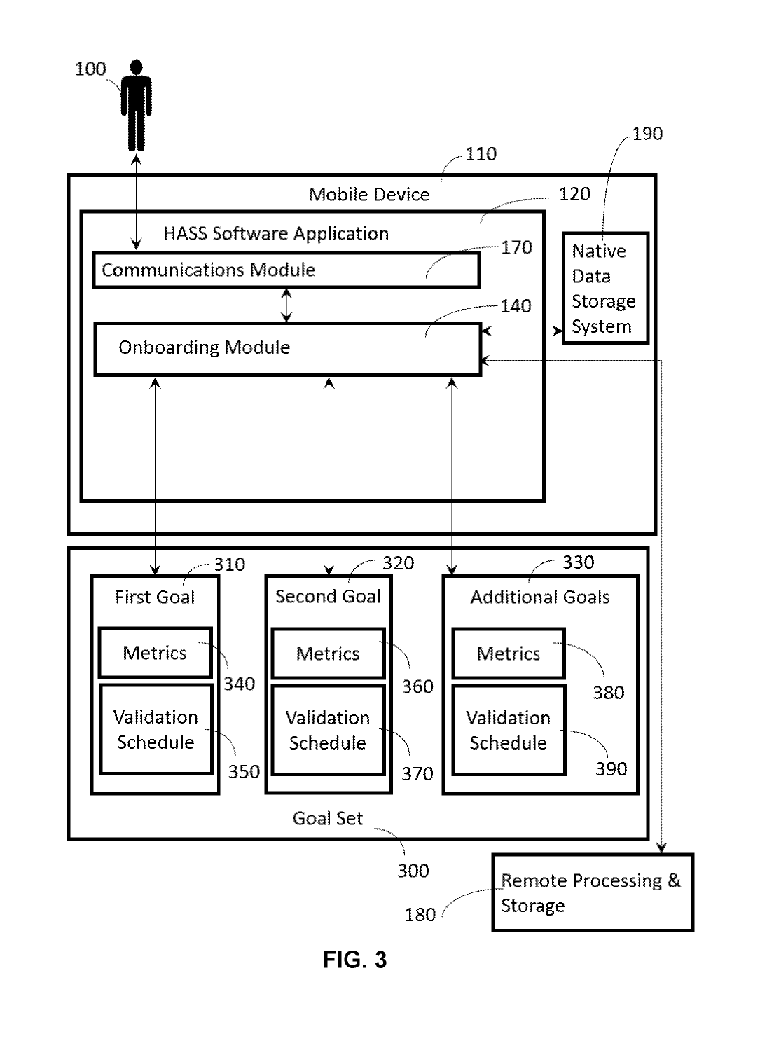

Onboarding Module: Goals. FIG. 3 illustrates the initial stage of a Goal registration process in some embodiments of the HASS Application. After personal data, constraints, tracking applications and devices have been registered, the Onboarding Module, 140, may ask the User to register a number of Goals of the Goal Set, 300. For example, Goals within this set (310, 320, 330) might relate to reduced weight, decreased body fat, increased muscle mass, improved sleep patterns, reduction in detrimental addiction behavior, or any other health objectives of interest to the User that are supported by the HASS Application. The number of Goals that a User may register within the User's Goal Set is not fixed and may include either a multiplicity of Goals or just one Goal if the User so chooses.

Onboarding Module: Metrics. For each Goal within the Goal Set, the User, 100, may register a set of Metrics (340, 360, and 380) that will help the User assess progress toward the Goal. The User, 100, may choose multiple Metrics from pick lists generated by the Onboarding Module for each Goal within the Goal Set. The User may also set one or more custom Metrics if the User does not find Metrics in the preconfigured pick list that are consistent with the User's objectives. For instance, if the User's Goal, 310, is to increase the User's strength, the User may assess strength by the maximum number of selected exercises the User can perform continuously until failure (e.g., pushups, chin ups, bench press at a given weight, curls with a given weight, etc.). Each selected exercise would constitute a Metric for the User's strength Goal.

Similarly, in the case that the User specifies an objective to lose weight, a dialogue panel GUI generated by the Onboarding Module, 140, may request more information about the User's target weight. The HASS Application may negotiate a schedule for the weight loss which will be achieved typically through a recommended calorie restricted diet plan, a recommended resistance exercise training regime (which typically includes a multiplicity of distinct workouts to be performed on different days of the week), and a recommended cardiovascular training regime (which may also include a multiplicity of workouts).

Metrics are stored on at least one Remote Processing and Storage System, 180. They may also be stored on a Native Data Storage System, 190, on the computational device, 110, used to engage with the HASS Application.

Onboarding Module: Validation Schedule. In addition, the User, 100, may set a Validation Schedule (350, 370, 390) for each Goal within the Goal Set, 300. The Validation Schedule is the interval at which progress toward a given Goal will be measured. Validation of progress might be assessed, for instance, every week, every two weeks, or every month. The Validation Schedule for each Goal within the Goal Set may be different or a single Validation Schedule may be set for the entire Goal Set. In the case that a single Validation Schedule is set for the entire Goal Set, the validation of progress toward each of the Goals may be staggered to occur on different days.

Validation Schedules are stored on at least one Remote Processing and Storage System, 180. They may also be stored on a Native Data Storage System, 190, on the computational device, 110, used to engage with the HASS Application.

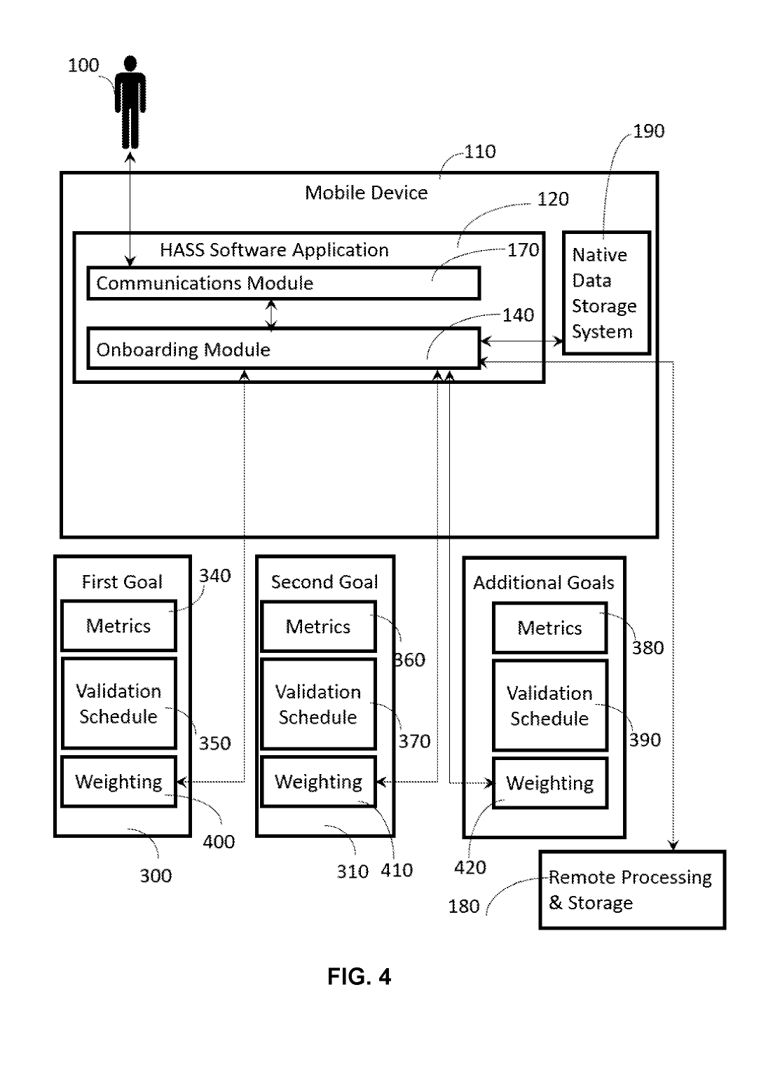

Onboarding Module: Weighting Parameters. FIG. 4 illustrates the registration of Weighting Parameters for each Goal within the Goal Set. When the User, 100, chooses to register multiple Goals within the User's Goal Set, the Onboarding Module, 140, may instruct the customer to enter these Goals in priority order. The Onboarding Module, 140, may register standard Weighting Parameters (400, 410, and 420) for these Goals associated with the order of their entry. Alternately, it may ask the User to specify Weighting Parameters for each Goal (400, 410, and 420). There may also be a requirement that the Weighting Parameters add up to 100 or some other pre-specified number. Ultimately, Weighting Parameters will be assigned to each Goal within the Goal Set, either by the User or by the Onboarding Module.

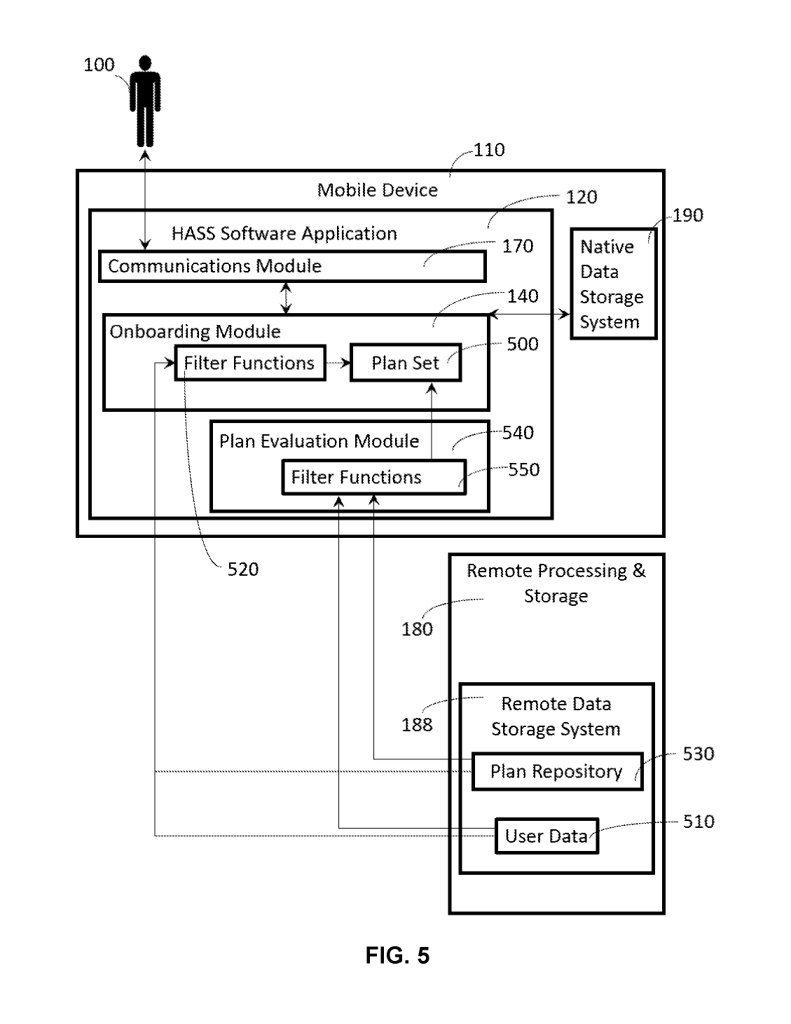

Onboarding Module: Plan Set. FIG. 5 illustrates the initiation of a Plan Set by the Onboarding Module, 140. The Onboarding Module provides the User, 100, with a Plan Set, 500 selected specifically to maximize the likelihood of realizing the User's Goal Set. The Onboarding Module accesses User data, 510, including personal data, personal constraints, the Goal Set, Metrics, Weighting Parameters, and Historical Data either from (a) memory of the computational device used to engage the HASS Application, (b) the Native Data Storage System, or (c) from a Remote Processing and Storage System. The Onboarding Module uses this data to engage Filter Functions, 520, to select a Plan Set from a preconfigured Plan Repository, 530, stored in at least one Remote Processing and Storage System. Plans within this Plan Set are presented to the User as options for prescriptive or prohibitive behavior patterns to optimize the likelihood that the User will achieve the User's Goal Set.

For example, consider, a case in which the User has selected a Goal Set to: (1) decrease body fat percentage, (2) improved cardiovascular health, and (3) improve sleep efficiency. The Onboarding Module may select Plans for diet, resistance exercise, cardiovascular training, motivation, and sleep hygiene from the Plan Repository with sensitivity to personal data, personal constraints, the Goal Set, the registered Metrics for each Goal, Weighting Parameters, and Historical Data for the User. Assume that Onboarding Module accesses the following data for the User:
1. Personal data for the User includes that the User is 400 lbs with 50% body fat and is categorized as morbidly obese. Historical Data for the User indicates that the User wakes an average of five times per night, does not have fixed times at which the User goes to sleep or wakes, and is in bed an average of 12 hours per day.
2. Personal constraints registered for the User indicate that the User has no access to gym equipment and has no technical expertise with resistance exercise and has an injured shoulder. Further, personal data reveals that the User prefers long walks for cardiovascular exercise.
3. Historical Data for the User indicates a strong correlation between ingestion of starchy carbohydrates and an increase in body fat. Meanwhile, correlations for ingestion of other macronutrients and an increase in body fat are much lower.
4. Additional Historical Data indicates that the User ingests much starchy carbohydrate while in bed.
5. Further, Historical Data collected from the Social Networking Module, 1660, of the HASS Application (illustrated in FIG. 16) indicates that the User has strong correlations to maintaining a prescribed diet and exercise regime when (a) in frequent contact with a personal trainer registered with the HASS Application, (b) in frequent contact with a social network of peers who are also struggling with obesity, and (c) the User joins a competitive team through the Social Networking Module that has chosen to be measured as a team on their average body fat percentage.
6. Weighting Parameters registered for the User indicate that the User has ascribed a strong weighting to decreasing body fat percentage and much lower weights to the User's other Goals.
7. The User has selected a Metric for the User's second Goal (improved cardiovascular health) that is the total time required for him to complete a 3-mile walk.

The Onboarding Module imposes a series of Filter Functions, 520, to select a preferred Plan Set from the Plan Repository that is sensitive to the above data. It may filter as follows:
1. A set of resistance exercise plans that uses only: (a) body weight exercises appropriate for an obese person, (b) exercises in each plan that do not put stress on an injured shoulder.
2. A set of cardiovascular plans that emphasize walking and speed walking.
3. A set of diet plans that are differentiated by reduced ingestion of starchy carbohydrates.
4. A sleep plan that recommends a fixed time for bed and to wake. A prescribed limitation of eight hours in bed with no eating in bed.
5. A motivational plan that emphasizes increased contact with a personal trainer and increased social networking with groups registered in the HASS Application that are obese. The motivational plan might also recommend joining teams registered in the HASS Application that are evaluated regularly on average body fat percentage and aggregate distance walked.

Several other variations with distinct Filter Functions appropriate to different Users are possible for selecting a Plan Set from the Plan Repository.

After initial selection of a Plan Set by the Onboarding Module, the Plan Set is evaluated regularly by a Plan Evaluation Module, 540. The recommended Plan Set may change as more Historical Data is acquired and Filter Functions, 550, used by the Plan Evaluation Module change over time. Plans may also change due to recommendations from a personal trainer, dietician, or other health professional.

The Plan Set, 500, is stored in at least one Remote Processing and Storage System, 180, and may also be stored natively, 190, on the computational device used to engage the HASS Application.

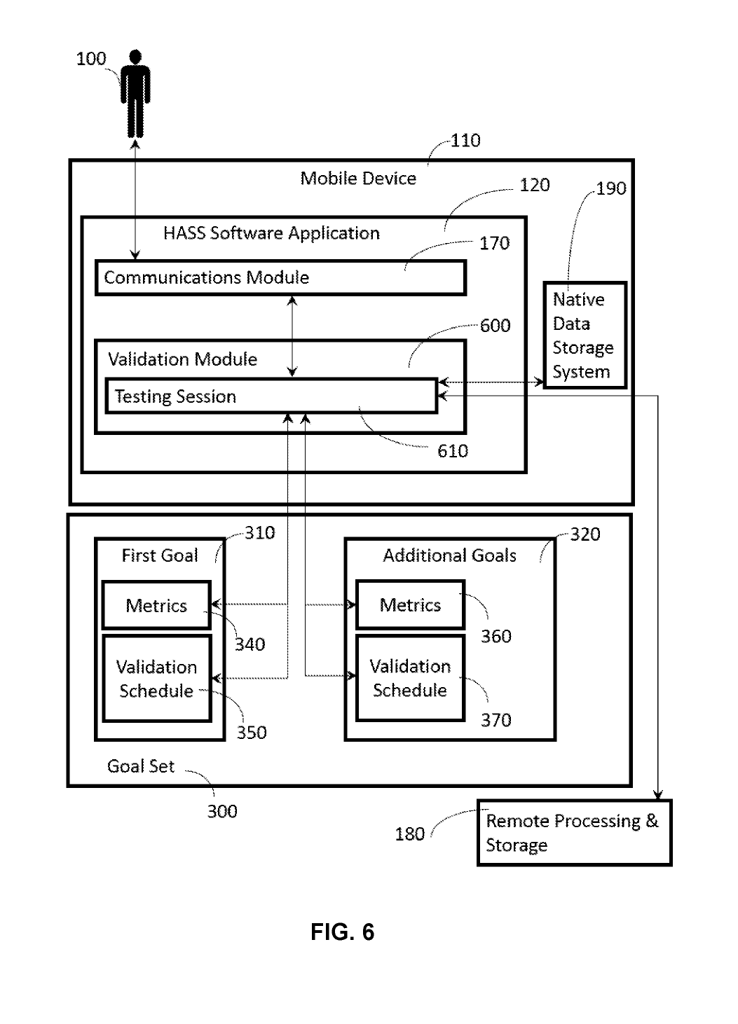

Validation Module: Testing Sessions. FIG. 6 illustrates the management of Testing Sessions, 610, by the Validation Module, 600. The HASS Application, 120, through its Validation Module, 600, provides automated reminders to the User according to a configured Validation Schedule (350, 370) for each Goal within the Goal Set. The Validation Module, 600, requests that the User, 100, initiate a Testing Session, 610, for one or more Goals within the Goal Set. In each Testing Session, the Validation Module presents the User with an interactive panel in which the User can record the results of each stage of the Testing Session. Frequently, the Testing Session is designed to assess progress for each Metric registered by the User for a specific Goal within the Goal Set. For instance, a given Testing Session might assess a Goal registered by the User for increased strength. The Testing Session might cycle through each of the Metrics registered by the User for this increased strength Goal. Metrics might include, for example, the maximum number of distinct exercises that can be performed continuously until failure. Similarly, a Testing Session that evaluates endurance might assess how long it takes the User to perform a given cardiovascular training session (e.g., a standardized 5 mile run).

Results of each Testing Session (with respect to each selected Metric for each of the Goals within the Goal Set) are transmitted to at least one Remote Processing and Storage System, 180. Test results may also be stored on a Native Data Storage System, 190, on the computational device, 110, used to engage with the HASS Application, 120.

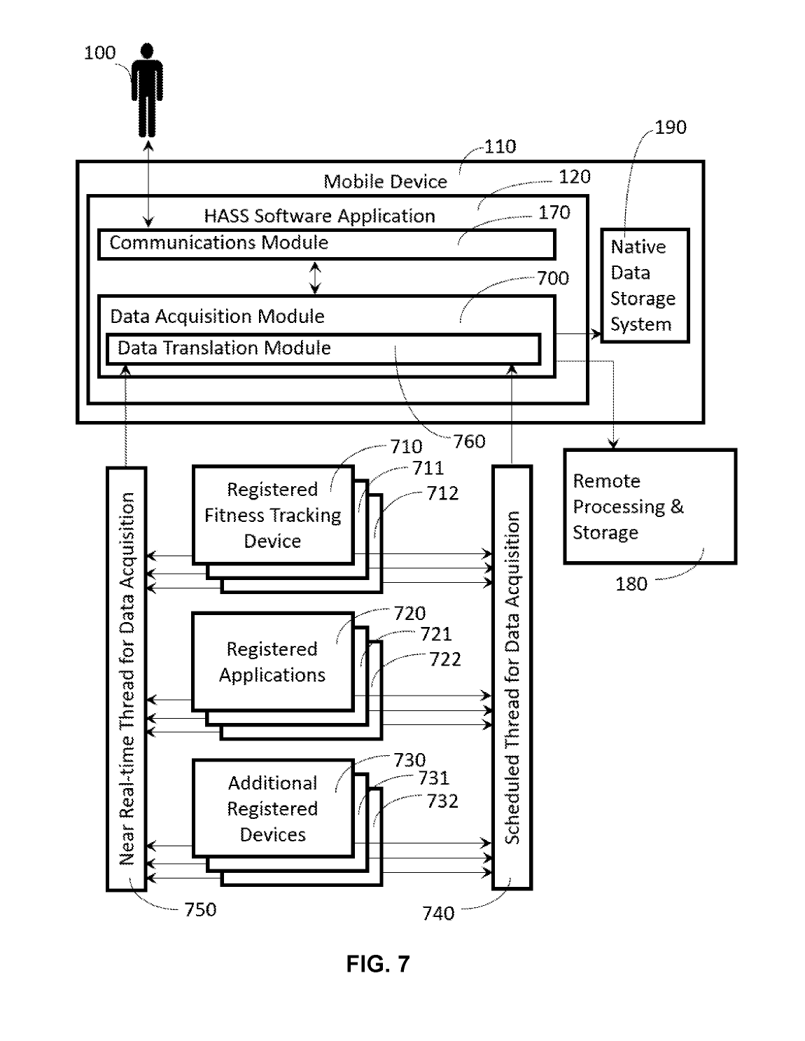

Data Acquisition Module: data acquisition from registered devices and applications. FIG. 7 illustrates management of data acquisition from a multiplicity of registered devices and applications (710-712, 720-722, and 730-732) by the Data Acquisition Module, 700. For some data, the HASS Application may update its systems according to a schedule (e.g., every several hours, daily, or every few days). In such cases, the Data Acquisition Module will upload to the Remote Processing and Storage System, 180, all data acquired for a given User from registered devices and applications using a scheduled thread for data acquisition, 740. Such data may include minute by minute records for heart rate, sleep efficiency, wakefulness, restlessness, activity calories, caloric intake, body weight, body fat percentage, blood pressure, skin temperature, blood sugar levels, and the like. This data is stored in at least one Remote Processing and Storage System. It may also be stored natively on the appliance that is used to engage the HASS Application. Since a multiplicity of Users is served by the HASS Application, the Communications Module, 170, may stage uploads to the Remote Data Storage System so that they are load balanced across Users and result in a consistent rate of traffic flow to each Remote Processing and Storage System.

In other cases, data may be uploaded to one or more Remote Processing and Storage System in near real-time, 750, as registered devices and applications acquire it and such data becomes available to the HASS Application through an API or through some sharing system such as the Apple HealthKit™ or Google Fit™. Such data may be used to notify one or more Users of specific behaviors that have been classified by the HASS Application or its component modules as beneficial or detrimental to achieving their respective Goal Sets. The HASS Application may need to provide credentials to the accounts associated with some registered devices and/or applications.

In some cases, the Data Acquisition Module may need to ascertain which of the registered fitness tracking devices has new data for acquisition. The Data Acquisition Module, 600, may poll all registered devices and applications at a periodic scheduled interval for certain types of data and in near-real time for other types of data. In some cases, the Data Acquisition Module may need to correct systematic differences that may occur between distinct devices and applications. For instance, different fitness tracking devices may use different methodologies for calculating activity calories, sleep efficiency, body fat percentage, caloric requirements, and other health or fitness metrics. If necessary, the Data Acquisition Module will engage the Data Translation Module, 660, to correct these systematic differences that depend on a particular device or application. Its goal is to approximate as closely as possible uniform standards for data collection from all data sources.

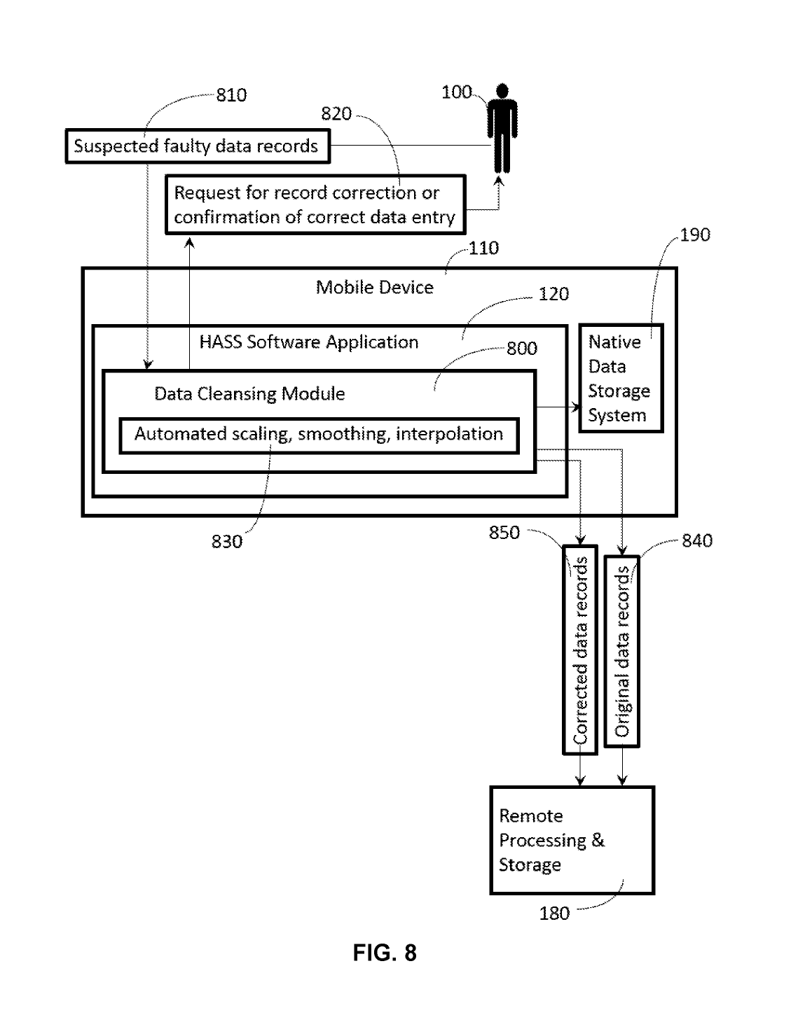

Data Cleansing Module. FIG. 8 illustrates data correction by the Data Cleansing Module, 800. The purpose of this module is to correct inconsistencies in data entry that may be caused by the User's failure to enter data consistently.

For instance, the User may fail to enter into the appropriate registered calorie counting application all food the User has ingested through the day, 810. The Data Cleansing Module might deduce that an omission in the entry of food data is likely by detecting a gap in the food intake record (for example, absence of a meal) followed by an otherwise inexplicable gain in body weight. Similarly, the User may record very low caloric intake for a given day, followed by an unreasonable gain of body weight. Under these circumstances, probabilities are that the User did not enter all food the User ingested. The Data Cleansing Module, 800, may attempt to correct the presumed failure of data entry in multiple ways. In one embodiment, it might push a notification to the User to indicate an anomaly, 820. In this case, the Data Cleansing Module may request that the User either (a) confirm that the User correctly entered all food data, or (b) correct the corresponding gap in the data record by entering the missing data. Alternately, the Data Cleansing Module, might adjust automatically the food record, 830, based on an assessment that failure to enter data is the most likely cause of an identified anomaly.

Another example by which the Data Cleansing Module may adjust the data record automatically, may occur if it detects anomalies in measurements for body weight or body fat percentage. For greatest accuracy, body weight should always be measured under consistent conditions. However, the User may not measure the User's body weight for several days or measure it at different times of day. The Data Cleansing Module may adjust the data record by interpolating between entries, scaling entries to correct for systematic errors, smoothing data to correct for random errors associated with the data entry process, or perform a regression analysis to provide corrections of stochastic error in the data record, 830.

The Data Cleansing Module records both the corrected data records, 840, and also the original data records, 850, in one or more Remote Processing and Storage Systems, 180. It may also retain the records on storage native, 190, to the computational device that is used to engage with the HASS Application 110.

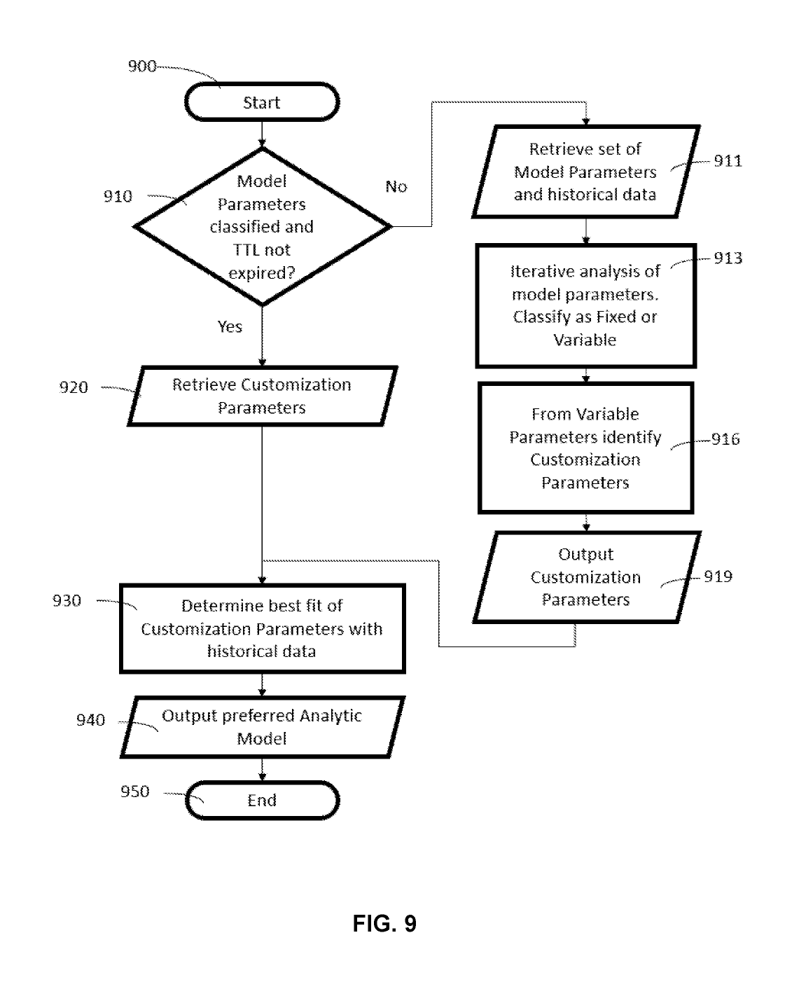

Analytics Module. FIGS. 9 through 15 illustrate different embodiments of methods for generating Models by the Analytics Module. The HASS Application generates either an Analytic Model, a Composite Analytic Model, a set of Structural Equation Models (SEMs), or some combination of these to enable multi-objective optimization for the User's Goal Set inclusive of their assigned Weighting Parameters and subject to the personal data and personal constraints that have been identified via User input. In the case that only one Goal has registered with the HASS Application, the task of multi-objective optimization reduces to a case of single objective optimization. The Analytics Module may use multiple methodologies to achieve the optimization. Further, distinct methodologies may be selected for different Goals within the Goal Set.

Analytics Module: single Analytic Model. For some objectives identified by the User, the HASS Application may presuppose a single Analytic Model that purports to describe the mechanisms of the relevant biological process, psychological process, or behavioral habit pattern for a population. For instance, an Analytic Model may be developed through modelling independent chemical, biological processes, or psychological processes associated with each Goal in the Goal Set. This Analytic Model may be developed through any of a number of distinct methodologies. Model Parameters associated with the Analytic Model must be determined through linear regression, multiple linear regression, non-linear regression, or some other optimization technique that achieves a best fit with Historical Data.

In FIG. 9, the Analytics Module is initiated, 900, and then determines whether the Model Parameters have already been classified in some previous operation and whether the corresponding Time To Live (TTL) value has expired, 910. This step is important because the Analytics Module must, according to a periodic schedule, re-evaluate whether previously obtained best fit values are still preferred in light of new Historical Data that has been acquired. If Model Parameters have already been classified and TTL has not yet expired, the Analytics Module retrieves the Customized Parameters (defined below) from storage, 920.

Selection of Customized Parameters. If the Model Parameters have not yet been classified or the TTL has expired, the Analytics Module retrieves the set of Model Parameters from storage along with Historical Data for the User and other Users, 911. If there is insufficient Historical Data for the User, the Analytics Module may retrieve Historical Data from Users deemed similar to the User by an automated filter function, 911. The Analytics Module then classifies the Model Parameters into two categories by performing independent best fit analysis (e.g., through general linear regression, non-linear regression, or some other optimization technique) for a multiplicity of individuals and groups within the population, 913, with a multiplicity of Historical Data sets, 913. Those parameters that do not vary between individuals or groups more than some pre-established threshold (e.g., 10%) are classified as Fixed Parameters, whereas those parameters that vary significantly between individuals or groups of individuals are classified as Variable Parameters, 913. The Analytics Module selects a subset of the Variable Parameters as the Customized Parameters, 916. Often Customized Parameters are selected either: (a) as parameters that have the greatest variance value for the sample population, (b) as parameters that have greatest relevance to the User's Goal Set, and (c) are most easily reproducible for different samples from the Historical Data for the given User, by virtue of having minimal variance in values over time for the given User. The Analytics Module then outputs to storage the list of Customized Parameters, 919.

Determination of values for Customized Parameters. The Analytics Module then determines best fit values for the Customized Parameters by any one of a number of methodologies, 930. It may, for instance, perform linear regression, multiple linear regression, non-linear regression, or some other optimization methodology, using the Historical Data for the User and Historical Data from a sample population of Users. Note that this methodology does not presuppose a mathematical model that is customized through a corrective process. The Analytic Model developed by the Analytics Module is determined by the best fit values for the Model Parameters, in particular the Customized Parameters. In this fashion, the Analytics Module generates a unique Analytic Model for a given User.

In an example embodiment, the Analytics Module determines the Customized Parameters, 930, through an optimization process. At each iteration, the Analytics Module selects seed values for the Customized Parameters. It then performs an optimization search for preferred seed values for the next iteration. It may, for instance, attempt to achieve a best fit with the Historical Data by adding the Historical Data variances from the curve predicted by the initial seed values. At each iteration, the Analytics Module may calculate (a) gradients of the Variance and adjust values of the Customized Parameters along the line of steepest descent, (b) perform searches for improved fits with quadratic functions, (c) deploy a genetic algorithm, or (d) execute another comparable optimization strategy. These processes conclude with candidate values for the set of Customized Parameters, 930. In cases, where the Customized Parameters are subject to constraints, the Analytics Module accounts for these constraints in its optimization searches, 930. With some methodologies, there is a risk of identifying only a local minimum of variation with the Historical Data and not a global minimum. To avoid the likelihood of such a misidentification, the Analytics Module may perform the optimization search multiple times choosing each time distinct seed values widely dispersed (i.e., having a minimum prescribed distance from each other in the phase space of the optimization parameters). In cases where a local minimum was incorrectly identified as a global minimum, the Analytics Module selects the global minimum and identifies it with the corresponding Customized Parameter.

In cases, where the User has insufficient Historical Data for the processes described above to converge reliably to a set of Customized Parameters (for instance, because the User has just registered with the service), the Analytics Module may choose to determine the parameters by using Historical Data for a group of Users deemed similar to the given User by an automated filter function. As before, one of a number of methodologies might be used to determine a best fit for the Customized Parameters (e.g., linear regression, non-linear regression, iterative optimization search strategies, and the like). If a group of Users deemed similar by a filter function is used to generate an initial set of Customized Parameters, the Analytics Module will supplant these values with new ones generated from the Historical Data for the User once sufficient Historical Data for the given User has been acquired. As noted above, as new Historical Data is acquired, the Analytics Module performs a periodic search for best fit Customized Parameters. These new values supplant earlier best fit values if they provide a better fit to the relevant Historical Data.

The values of the Model Parameters, are output to storage, 940, and the method terminates 950. After a preferred set of Customized Parameters have been identified (that achieve a best fit with the User's Historical Data while not violating the constraints), these values are reported to the User by the Communications Module. Further, information is provided about how these unique values might influence the trajectory for that User to achieve the User's Goals. For instance, when modelling metabolism, the Analytics Module may identify that a best fit to the User's Historical Data is achieved with an unusually low Resting Metabolic Rate (i.e., a Resting Metabolic Rate that is lower than for a subset of the population deemed similar to the User by an automated filter function). This low value will likely make achieving weight loss Goals more difficult than for another member of the population that in other respects is similar to the User. This extra element of difficulty is reported to the User through the Communications Module. The Model generation process then terminates, 950.

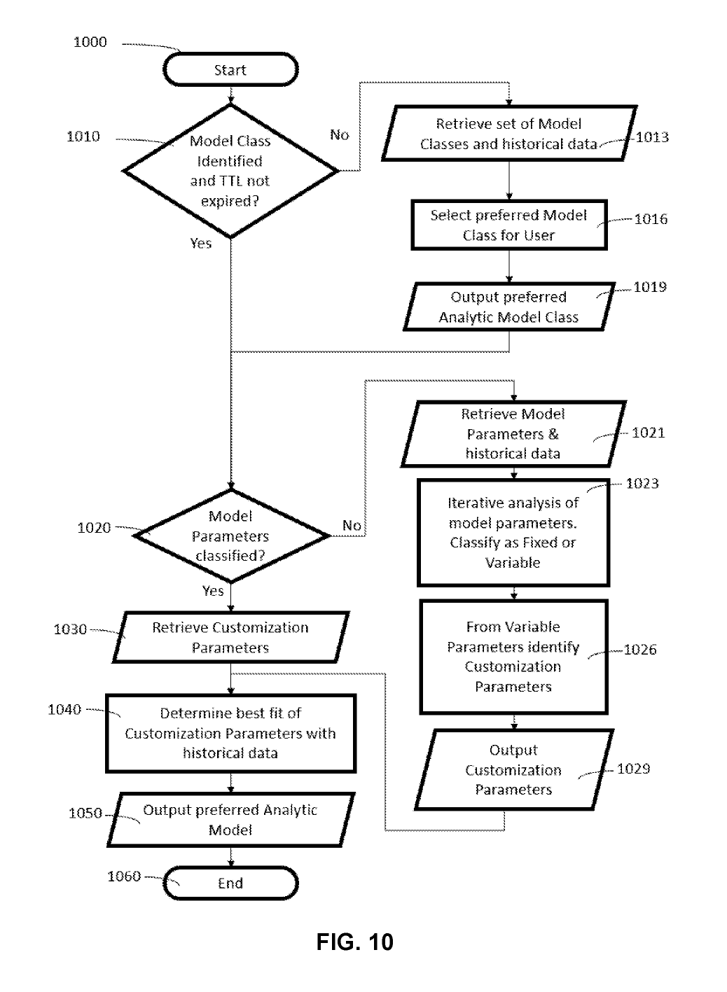

Analytics Module: Analytic Model Class. FIG. 10 illustrates an embodiment of the Analytics Module in which generating a Model involves assessing a multiplicity of distinct Model Classes that are appropriate to different segments of the population (e.g., children, seniors, pregnant women, the morbidly obese, or Olympic athletes).

The Analytics Module is initiated, 1000, and first assesses whether a preferred Model Class has already been identified and whether the Time To Live (TTL) parameter has yet expired, 1010. This step is important because the Analytics Module must, according to a periodic schedule, re-evaluate whether previously obtained Customized Parameters are still preferred in light of new Historical Data that has been acquired. If a preferred Model Class has already been identified and the TTL has not yet expired, the Analytics Module proceeds to task 1020 (described below).

If no preferred Model Class has yet been identified or the TTL has expired, the Analytics Module retrieves from storage a multiplicity of distinct Model Classes relevant to the particular Goal under analysis, 1013. The Analytics Module also retrieves Historical Data for the User from storage, 1013. In the event that insufficient Historical Data is available for the User, the Analytics Module may retrieve Historical Data for a segment of the population deemed similar to the User by an automated filter function, 1013. The Analytics Module uses Historical Data to map the User into a Model Class, 1016. It then outputs to storage the preferred Analytic Model Class for the User, 1019. The Analytics Module then determines whether Model Parameters have already been classified, 1020.

If not, the Analytics Module retrieves relevant Model Parameters and Historical Data for the User, 1021, along with Historical Data from other Users. The Analytics Module performs an iterative analysis of Model Parameters with respect to different sets of Historical Data. The Analytics Module classifies these Model Parameters into two categories by performing independent best fit analysis (e.g., through general linear regression or some other optimization methodology) for a multiplicity of individuals and groups within the population, 1023, with a multiplicity of Historical Data sets, 1023. Those parameters that do not vary between individuals or groups more than some pre-established threshold (e.g., 10%) are classified as Fixed Parameters, 1023. Those parameters that vary significantly between individuals or groups of individuals are classified as Variable Parameters, 1023. The Analytics Module selects a subset of the Variable Parameters as the Customized Parameters, 1026. Often Customized Parameters are selected either: (a) as parameters that vary most significantly between individuals or groups of individuals, (b) as parameters that have the greatest relevance to the User's Goal Set, and (c) are most easily reproducible as best fit optimizations for different samples of the User's Historical Data. The Analytics Module then outputs to storage the set of Customized Parameters it has identified, 1029.

In the event that Model Parameters have already been classified and the TTL has not yet expired, the Analytics Module retrieves from storage the previously calculated Customized Parameters, 1030.

The Analytics Module then follows a methodology comparable to that outlined in FIG. 9 to identify the best fit values for the Customized Parameters with the Historical Data for the User (or, in the event that the User has insufficient data for such an analysis, it evaluates the best fit values for the Customized Parameters using Historical Data from a group deemed similar to the User by an automated filter function), 1040. The Analytics Module then outputs the best fit values of the Customized Parameters to storage, 1050. The Model generation process then terminates, 1060.

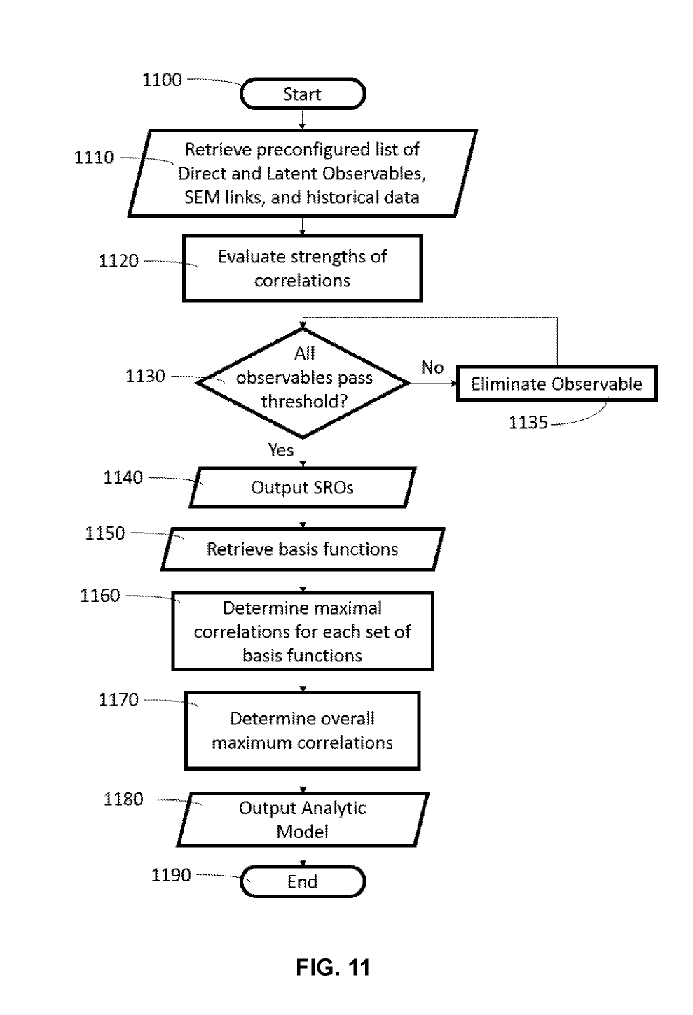

Analytics Module: data driven Analytic Model. FIG. 11 illustrates another embodiment of the Analytics Module which generates a Model through a data driven methodology.

The Analytics Module is initiated, 1100, and begins by retrieving from storage a preconfigured set of Direct and Latent Observables, 1110, that prior experience suggests have relevance to the biological processes, psychological processes, and/or behavior patterns that the User wants to modify through a given Goal within the User's Goal Set. The Analytics Module also retrieves the Historical Data for the User and, where appropriate, the path linkages for the corresponding SEM, 1110. In the event that insufficient Historical Data is available for the User, the Analytics Module may retrieve Historical Data from a group deemed similar to the User by an automated filter function, 1110. The Analytics Module then evaluates correlations between: (a) the preconfigured set of Direct and Latent Observables and (b) the Historical Data for the path links specified in the corresponding SEM, 1120.

Through an automated iterative process, the Analytics Module identifies a subset of the Direct and Latent Observables that have significant correlations with each other (e.g., standardized correlation values whose absolute value exceeds some pre-established threshold), 1130. The iterative search may involve selecting at each iteration a selected observable to eliminate, 1135. In some cases, the search for correlations between the Direct and Latent Observables may be informed by logical considerations or prior experience with the observables. The final subset of Observables identified through this process we label as the Statistically Relevant Observables (SROs). Once the Analytics Module has identified the SROs, it outputs them to storage for future reference, 1140.

With the SROs identified, the Analytics Module performs additional analysis to identify non-linear relationships between observables. The Analytics Module attempts to maximize correlations between the SROs through an iterative procedure. The Analytics Module retrieves a set of preconfigured basis functions from storage to identify functions that underlie non-linear relationships, 1150. The preconfigured basis functions (e.g., powers, sinusoids, fractal functions, exponentials, or other functions) are constructed from the set of SROs. Through an iterative search, the Analytics Module evaluates maximal correlations for each set of basis functions, 1160. The Analytics Module then determines the overall maximum correlations across all sets of basis functions, 1170. The set of basis functions with the overall maximum correlations, determines an Analytic Model. This model is output to storage, 1180, and is used subsequently as the preferred Analytic Model for the biological process, psychological process, or behavior pattern that the User seeks to modify. The Model generation process then terminates, 1190.

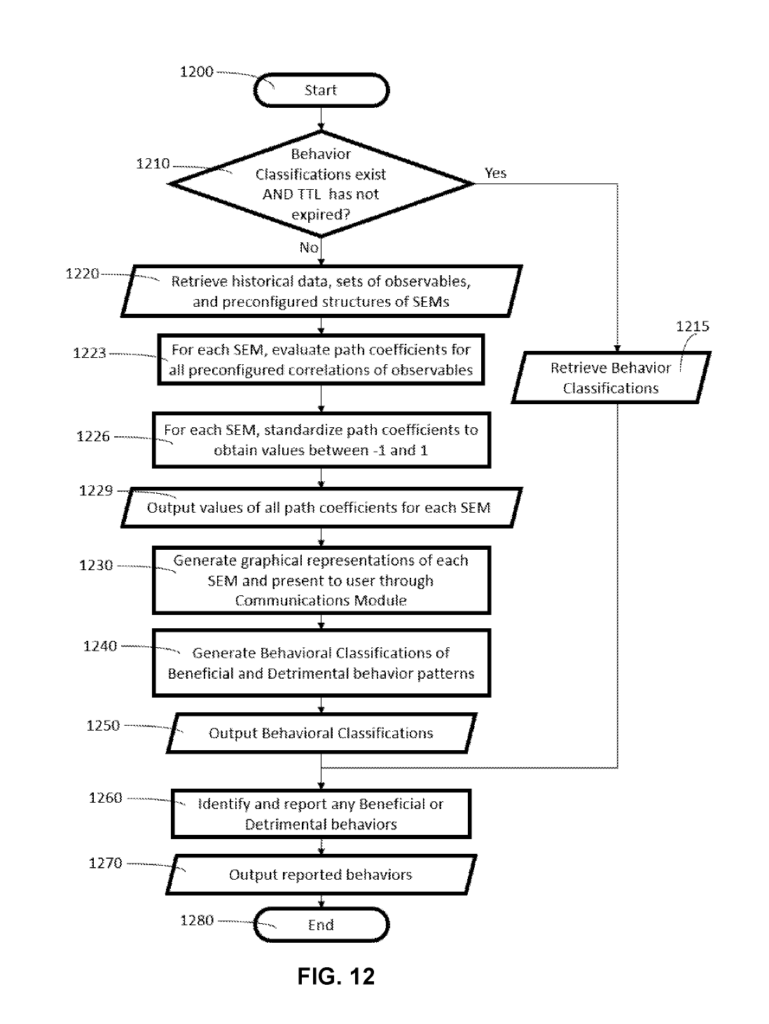

Analytics Module: Statistical Structural Equation Models. FIG. 12 illustrates another embodiment of the Analytics Module, which generates a Statistical Model, which may comprise a set of Structural Equation Models (SEMs), that identify the strengths of correlations between observables related to the User's Goal Set.

Note that there may exist a multiplicity of SEMs for a single Goal Set. There may be, for instance, hierarchical SEMs that provide either a greater or lesser degree of granularity with respect to different observables. For instance, one SEM for metabolism may only be sensitive to the calorie differential between calories ingested and calories expended. Other SEMs in the set may also have sensitivity to the distribution of macronutrients ingested, times of day for calories ingested, exercise modalities, exercise intensity, exercise frequency, and exercise duration. There may also be a multiplicity of SEMs that relate to different Goals within the User's Goal Set.

The Analytics Module also uses the path coefficients for the set of SEMs to generate Behavior Classifications. In particular, it classifies behaviors as beneficial or detrimental to the User being able to achieve the User's registered Goal Set. Further, Behavior Classifications have a preconfigured Time To Live (TTL). Once this time has expired, new Behavior Classifications must be generated through a new evaluation of the path coefficients for the set of SEMs.

The Analytics Module is initiated, 1200, and first determines, 1210, whether: (a) Behavioral Classifications already exist AND (b) the Time To Live (TTL) for these classifications has not expired. If both these conditions are met, the Analytics Module retrieves the Behavior Classifications from storage, 1215, and proceeds to task 1260, described below.

If one or both of these conditions is not met, the Analytics Module retrieves, 1220, from storage: (a) Historical Data for the User, (b) preconfigured lists of Observables (both Direct and Latent Observables) relevant to each SEM with the set, and (c) the preconfigured SEM structure for each SEM within the set. The Analytics Module then evaluates the SEM path coefficients for all preconfigured correlations identified within the preconfigured structure for each SEM within the set, 1223. The Analytics Module then standardizes the path coefficients it has obtained so that all values are normalized to lie between [−1 and 1], 1226. The Analytics Module then outputs to storage the path coefficients it has derived for each SEM in the set, 1229.

Next, the Analytics Module generates one or more graphical representations of each SEM and presents these to the User through one or more Graphical User Interface (GUI), 1230. Using the values of the path coefficients, the Analytics Module then generates Behavior Classifications,1240. Behaviors that support the User's Goal Set with an absolute value of the corresponding path coefficient that surpasses some preconfigured threshold are classified as beneficial. Behaviors that have a strong negative correlation with the User's Goal Set are classified as detrimental. The Analytics Module then outputs to storage its new Behavioral Classifications, 1250.

The Analytics Module then examines Historical Data for the User within its polling interval (e.g., less than the TTL). It then identifies and reports to the User recent behaviors that are either beneficial or detrimental to achieving the Goal Set, 1260. Finally, the Analytics Module outputs to storage any behaviors that it has reported to the User, 1270. The Model generation process then terminates, 1280.

For instance, assume that the User is interested to lose weight. Further assume that the Analytics Module identifies a correlation between (a) eating fatty food within a certain time window before sleep and (b) increased weight. If the correlation is sufficiently strong to pass a preconfigured threshold test, the Analytics Module identifies this behavior as detrimental to the User. The Communication Module will then report to the User a recommendation to avoid eating fatty food during this time window before sleep. Similarly, if the Analytics Module finds a correlation between (a) morning cardiovascular exercise with duration of at least 30 minutes and (b) weight loss, it may report to the User through the Communications Module that this behavior is beneficial to achieving the Goal Set. In addition, by presenting the SEM set with the values of all path coefficients, the Analytics Module reports on a multiplicity of correlations (along with the strengths of these correlations) that have bearing on one or more Goals within the User's Goal Set.

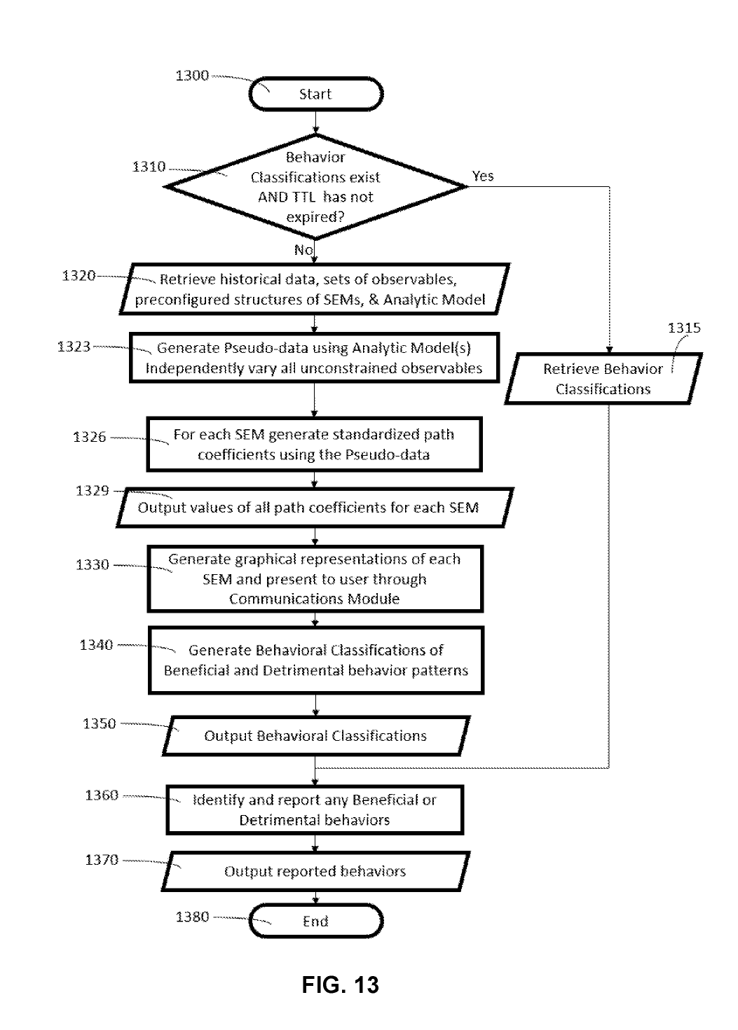

FIG. 13 illustrates additional features of some embodiments of the Analytics Module. In cases where there is insufficient Historical Data for a User to generate a set of SEMs, the Analytics Module, may generate Pseudo-data using Analytic Model(s) for the Goal Set. The Pseudo-data is generated by using Model Parameters and, in particular Customization Parameters, for a group of Users deemed similar to the given User by an automated filter function. Independent observables for each SEM are varied by a number of standard deviations (as defined with respect to the Historical Data for a group of Users deemed similar to the given User by an automated filter function). The Analytic Model(s) are used to generate corresponding data for the dependent observables. The Pseudo-data set is then used to generate a set of SEMs complete with path coefficients. These path coefficients are then used to classify behaviors as beneficial or detrimental to achieving the Goal Set.

The Analytics Module is initiated, 1300, and first determines, 1310, whether: (a) Behavioral Classifications already exist AND (b) the Time To Live (TTL) for these classifications has not expired. If both these conditions are met, the Analytics Module retrieves the Behavior Classifications from storage, 1315, and proceeds to task 1360, described below.

If one or both of these conditions is not met, the Analytics Module retrieves from storage, 1320: (a) Historical Data for a group of Users deemed similar to the User by an automated filter function, (b) preconfigured lists of Observables (both Direct and Latent Observables) relevant to each SEM with the set, and (c) the preconfigured SEM path linkages (i.e., SEM structure) for each SEM within the set, and (d) the Analytic Model relevant to the Goal or Goal Set. The Analytics Module then varies each independent observable up and down by a fixed number of standard deviations (as defined relative to the Historical Data for the User group) and uses the Analytic Model(s) to generate Pseudo-data for the dependent observables, 1323. In some embodiments, the Analytics Module varies each independent observable in sequence while leaving other independent observables at their mean values. In cases of constrained independent observables, the Pseudo-data is generated while respecting the constraints.

Once the Pseudo-data has been generated, the Analytics Module performs multivariate analysis to generate a full set of standardized path coefficients for each SEM with the set of SEMs that will be presented to the User, 1326. The Analytics Module then outputs the path coefficients it has derived for each SEM to storage, 1329.

Next, the Analytics Module triggers the Communications Module to generate one or more graphical representations of each SEM and presents these to the User through one or more Graphical User Interface (GUI), 1330. Using the values of the path coefficients, the Analytics Module then generates Behavior Classifications,1340. Behaviors that support the User's Goal Set with an absolute value of the corresponding path coefficient that surpasses some preconfigured threshold are classified as beneficial. Behaviors that have a strong negative correlation with the User's Goal Set are classified as detrimental. The Analytics Module then outputs to storage its new Behavioral Classifications, 1350.

The Analytics Module then examines Historical Data for the User within its polling interval (e.g., less than the TTL). It then classifies and reports to the User through one or more GUI any recent behavior that is either beneficial or detrimental to achieving the Goal Set, 1360. Finally, the Analytics Module outputs to storage any behaviors that it has reported to the User, 1370. The Model generation process then terminates, 1380.

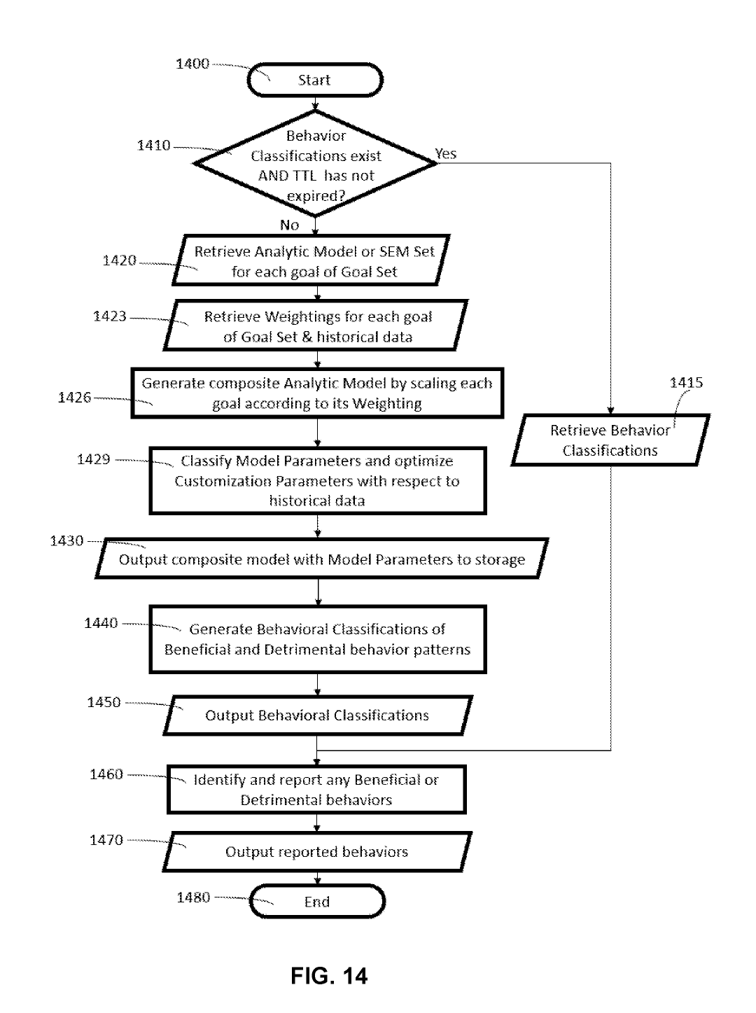

Analytics Module: Composite Analytic Model. FIG. 14 illustrates an embodiment of the Analytics Module which generates a Composite Analytic Model for a multiplicity of independent biological and psychological processes that are relevant to multiple Goals in the User's Goal Set. The Composite Analytic Model is generated using the Weighting Parameters that have been prescribed by the User or by a component of the HASS Application as scale factors for each Analytic Model to generate a global function. The Composite Analytic Model may, for instance, include multiple Analytic Models each with its own set of differential equations that collectively describe variations in dependent observables subject to changes to a set of independent variables.

The Analytics Module is initiated, 1400, and first determines, 1410, whether: (a) Behavioral Classifications already exist AND (b) the Time To Live (TTL) for these classifications has not expired. If both these conditions are met, the Analytics Module retrieves the Behavior Classifications from storage, 1415, and proceeds to task 1460, described below.

If one or both of these conditions is not met, the Analytics Module retrieves from storage Analytic Model(s) for each Goal in the Goal Set. It then retrieves from storage the Weighting Parameters for each Goal in the Goal Set along with Historical Data for the User or a group of Users deemed similar to the User by an automated filter function. The Analytics Module then generates a Composite Analytic Model from each of the constituent Analytic Models by adding them with each constituent Analytic Model scaled by its Weighting Parameter.

The Analytics Module then classifies the Model Parameters into two categories by performing independent best fit analysis (e.g., through general linear regression or some comparable optimization methodology) for a multiplicity of individuals and groups within the population with a multiplicity of Historical Data sets, 1429. Those parameters that do not vary between individuals or groups more than some pre-established threshold (e.g., 10%) are classified as Fixed Parameters, 1429. Those parameters that vary significantly between individuals or groups of individuals are classified as Variable Parameters, 1429. The Analytics Module selects a subset of the Variable Parameters as the Customized Parameters, 1429. Often Customized Parameters are selected either: (a) as parameters that have the greatest variance value for the sample population, (b) as parameters that have greatest relevance to the User's Goal Set, and (c) have minimum variance when determined by a best fit optimization with respect to different sets of the Historical Data for the given User. The Analytics Module then outputs to storage the list of Customized Parameters, 919.

Once a Composite Analytic Model has been obtained, the Analytics Module performs multi-objective optimization with respect to its Composite Analytic Model using iterative optimization strategies comparable to those described above (e.g., via gradient search methods, quadratic searches, genetic algorithms, and the like using a multiplicity of seed values). In some cases, distinct Goals within the User's Goal Set will be in conflict with one another. In such cases, the Weighting Parameters will determine an overall best fit between the Analytic Model and Historical Data for the User or a group of Users deemed similar to the User by an automated filter function. The Analytics Module then outputs to storage the Composite Analytic Model along with the set of Model Parameters it has identified, 1430.

The Analytics Module then generates Behavior Classifications,1440. Behaviors that support the User's Goal Set with an absolute value of the corresponding path coefficient that surpasses some preconfigured threshold are classified as beneficial. Behaviors that have a strong negative correlation with the User's Goal Set are classified as detrimental. The Analytics Module then outputs to storage its new Behavioral Classifications, 1450.

The Analytics Module then examines Historical Data for the User within its polling interval (e.g., less than the TTL). It then identifies and reports to the User through one or more GUI any recent behavior that is either beneficial or detrimental to the User achieving the User's registered Goal Set, 1460. Finally, the Analytics Module outputs to storage any behaviors that it has reported to the User, 1470. The Model generation process then terminates, 1480.

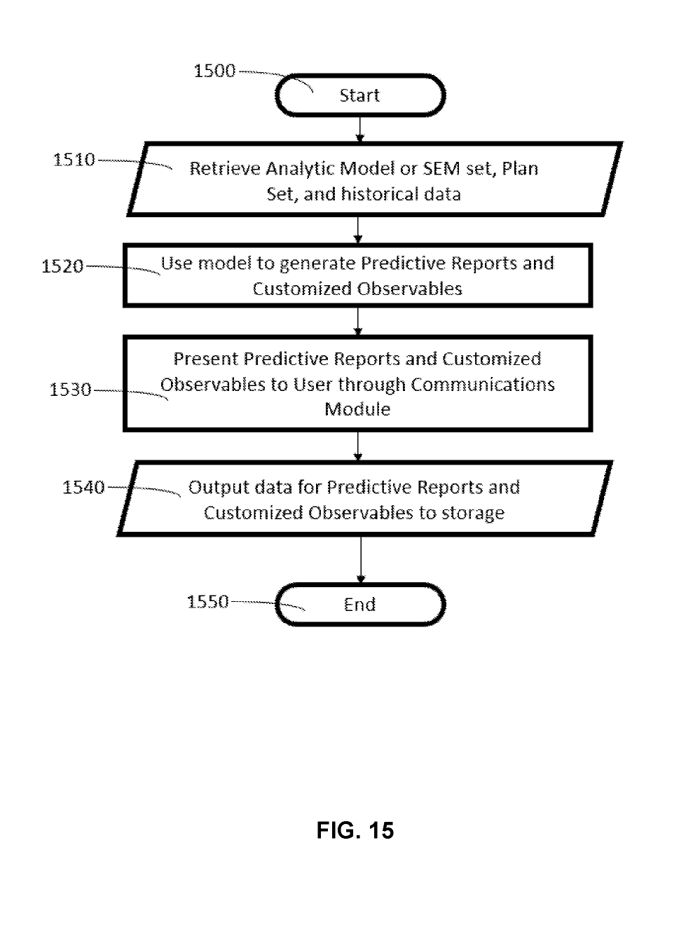

Analytics Module: Predictive Reports and Customized Observables. FIG. 15 illustrates the generation of Predictive Reports by the Analytics Module. The Analytics Module retrieves the Analytic Model, SEM set, or Composite Analytic Model from storage along with the Plan Set and Historical Data for the User (or, if insufficient data for the User is available, Historical Data for a group of Users deemed similar to the User by an automated filter function), 1510. The Analytics Module then uses the Historical Data to generate Predictive Reports for different behavior patterns, 1520. In particular, the Analytics Module may generate a Predictive Report for the cases where the User continues to behave as the User has been historically, along with one or more Predictive Reports that presume the User follows one or more plans in the Plan Set, 1520. The Analytics Module may also calculate Customized Observables, 1520. These are Observables of interest to the User that have been generated with the Customized Parameters. The Predictive Reports and Customized Observables are reported to the User through the Communications Module according to a prescribed schedule, 1530. The data for the Predictive Reports and Customized Observables is then output to storage, 1540. The Model generation process then terminates, 1550.

For example, in cases where the User specifies a Goal in the User's Goal Set related to body composition, the Analytics Module can generate Predictive Reports for body weight, body fat percentage, muscle mass, skeletal muscle efficiency, and other comparable Metrics. These Predictive Reports are generated subject to various assumptions about the behavior of the User. These may include a reduced calorie diet, different distributions of macronutrients within the caloric intake, a resistance exercise training regime, a cardiovascular training regime, or any combination of the above. The Analytics Module can also generate reports on Customized Observables that are of interest to the User. For instance, the Analytics Module may report on best fit values for the number of calories (potentially including a distribution of macronutrients) required to maintain current body weight, current body composition, or any comparable metric. Similarly, the Analytics Module, by identifying the strengths of various correlations and causal links in the Historical Data can identify preferred diets for a User subject to a specific Goal Set.

As the Analytics Module acquires more data, it performs a periodic iterative search to refine parameters and relationships within its preferred Analytic Model for each User.

If a User's behavior diverges significantly from the overall optimal trajectory prescribed by the Analytics Module, the Communication Module may push recommendations for change to the User. Similarly, if the User's behavior closely approximates a pattern consistent with the optimal trajectory, the Communication Module may present one or more messages to the User commending him for successful behavioral change.

Modifications to Plan Set. A further function of the Analytics Module is to identify modifications to the Plan Set that would generate an improved trajectory to the Goal Set subject to a set of constraints that has been identified by the User or a component of the HASS Application. Such modifications to the Plan Set are reported to the User through the Communications Module.

Example of Analytic Module Operation. Consider the functioning of the Analytic Module for an example of a 70 year old User who selects the following Goal Set:
1. Increased skeletal muscle mass; and
2. Reduced body fat percentage.

In this example, the Analytic Module generates a Composite Model. An Analytic Model for muscle hypertrophy/atrophy is available and is used for the first Goal, increased skeletal muscle mass. Further, an Analytic Model for metabolism is available and this model is used for the second Goal, reduced body fat percentage. In each case, the Analytic Module selects a Model Class that has sensitivity to sarcopenia, since the User is of an age range where this process is known to be relevant.

The Analytic Module then analyzes the Model Parameters for the two Goals to select a set Customized Parameters. Model Parameters that vary less than a preconfigured threshold are classified as Fixed Parameters. Those that vary more than the preconfigured threshold are classified as Variable Parameters. From the set of Variable Parameters, the Analytic Module must select a set of Customized Parameters. An automated filter function selects the Customized Parameters with sensitivity to three properties (the weighting of each property in the filter function will vary subject to the specific embodiment of the invention):
1. Maximal variance of each Model Parameter over the selected sample population;
2. Relevance of each Model Parameter to the User's registered Goals. Relevance is assessed with a parameter assigned through prior knowledge of the significance of each Model Parameter; and
3. Reproducibility for each User of the optimized value of the Model Parameter.
   The Analytic Module determines preferred values for each Customized Parameter through best fit optimization to the Historical Data of the User.

The Analytic Module retrieves the Weighting Parameters to create a global function with each Goal scaled by the appropriate Weighting Parameter. The model so generated can be used to provide predictive reports for skeletal muscle hypertrophy and body fat percentage subject to existing behavior patterns and behavior patterns prescribed by the HASS Application. In addition, the Composite Model can be used to generate a composite Structural Equation Model that can be presented to the User. Further, the path coefficients from the composite Structural Equation Model can be used to classify behavior that is beneficial and detrimental to the User achieving the User's Goal Set.

Social Network Module. In embodiments, the Social Networking Module, 1660, allows the Users to interface the HASS Application with social networking applications. For example, users may choose to share their personal data and personal constraints with other Users of the HASS Application. They may also engage filtering mechanisms to ensure that personal data and personal constraints are shared only with Users who satisfy a set of criteria. Each User may also filter out a set of Users that are of interest to him by using personal data and personal constraints that are shared by other Users. Users may advertise an interest in meeting Users that satisfy certain criteria. If one or more Users satisfying the criteria are identified that have not enabled personal data sharing, their personal data is shared with the advertiser only with explicit permission from the owners of that data. Users may also advertise to the HASS Application User Group (or subsets thereof), Goal Sets, Plan Sets, individual training plans, sleep plans, diet plans, motivational plans, or any other plans associated with the Goal Set along with corresponding Metrics. Users may generate followers. They may also join teams for the purposes of competition to achieve a given set of Goals. Users may report abusive behavior and block specific users.

Role Based Access Control (RBAC) Module. In embodiments, Role Based Access Control (RBAC) Module, 1650, allows a User to choose to allow a personal trainer, dietician, or some other professional registered with the HASS Application to set custom plans for the User. Such professionals can be granted privileges to the User's account. The scope of these privileges can be chosen by the User and may include the ability to read performance logs, set plans, analyze adherence to plans, or other privileges deemed appropriate by the User. Such professionals may also leverage the Social Networking Module to generate followers, advertise plans or metrics of interest, and/or create teams of Users for the purposes of competition.

Additional Definitions and Interpretation. References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such module, aspect, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

What is claimed is:

1. A method for assisting a User to achieve a Health-Related Goal Set, wherein the method is implemented by a processor operatively connected to a database and in communication via a communication network with a plurality of computing devices of the User and other Users, the method comprising periodically performing the steps of:
(a) receiving at the processor from one or more of the computing devices via the communication network, and storing and updating in the database, a record of Historical Data for the User or a group of the other Users deemed similar to the User by a filter function;
(b) generating a Model of one or more bodily or psychological processes relevant to the Goal Set of the User by one or a combination of:
(i) performing a best fit optimization of an Analytic Model to Observables in the record of Historical Data, to determine values for the User of Customized Parameter(s) comprising coefficients of the Analytic Model, and thereby fully specifying the Analytic Model; and
(ii) determining values of path coefficients of a Structural Equation Model (SEM) by determining values of correlation coefficients between linked Observables in the record of Historical Data, and thereby fully specifying the Structural Equation Model;
(c) evaluating at least one output based on the Model; and
(d) transmitting the output to the computing device of the User via the communication network.

2. The method of claim 1, wherein generating the Model further comprises selecting the Customized Parameter(s) to be determined from a Model Parameters Set based on at least one criterion comprising that the values of the Customized Parameter(s) for the group of Users have a variance that exceeds a threshold value.

3. The method of claim 1, wherein generating the Model further comprises selecting the Customized Parameter(s) to be determined from a Model Parameters Set based on at least one criterion comprising that the values of the Customized Parameter(s) for the User determined at different times have a variance that is less than a threshold value.

4. The method of claim 1, wherein generating the Model comprises performing the best fit optimization of the Analytic Model to Observables in the record of Historical Data, to determine values for the User of the Customized Parameter(s) comprising coefficients of the Analytic Model and thereby fully specifying the Analytic Model.

5. The method of claim 4, wherein generating the Model further comprises selecting the Analytic Model from an Analytic Model Class based on data indicative of personal characteristics or constraints of the User.

6. The method of claim 4, wherein the Analytic Model comprises a global function comprising the sum of a plurality of Analytic Models each of which is scaled by a Weighting Parameter associated with a different Goal within the Goal Set.

7. The method of claim 4, wherein generating the Model further comprises generating the Analytic Model from a preconfigured basis function.

8. The method of claim 7, wherein generating the Analytic Model from the preconfigured basis function is based on at least one criterion comprising that the determined value of the Customized Parameter(s) for the preconfigured basis function maximizes an absolute value of a correlation coefficient of the Model to the Observables in the record of Historical Data.

9. The method of claim 1, wherein generating the Model comprises determining values of path coefficients of a Structural Equation Model (SEM) by determining values of correlation coefficients between linked Observables in the record of Historical Data, and thereby fully specifying the Structural Equation Model.

10. The method of claim 1, wherein the output comprises values of the Observables of the Historical Data predicted by the generated Model.

11. The method of claim 1, wherein the output comprises a Plan selected automatically by another filter function from a Plan Repository stored in the database.

12. The method of claim 1, wherein the output comprises a classification of one of the Observables in the record of Historical Data for the User as either beneficial or detrimental to the User achieving the Goal Set.

13. A system for assisting a User to achieve a Health-Related Goal Set, the system comprising a processor operatively connected to a non-transitory computer readable memory, and a database, and in communication via a communication network with a plurality of computing devices of the User and other Users, the memory storing instructions executable by the processor to periodically implement a method comprising periodically performing the steps of:
(a) receiving at the process from one or more of the computing devices via the communication network, and storing and updating in the database, a record of Historical Data for the User or a group of the other Users deemed similar to the User by a filter function;
(b) generating a Model of one or more bodily or psychological processes relevant to the Goal Set of the User by one or a combination of:
(i) performing a best fit optimization of an Analytic Model to Observables in the record of Historical Data, to determine values for the User of Customized Parameter(s) comprising coefficients of the Analytic Model, and thereby fully specifying the Analytic Model; and
(ii) determining values of path coefficients of a Structural Equation Model (SEM) by determining values of correlation coefficients between linked Observables in the record of Historical Data, and thereby fully specifying the Structural Equation Model;
(c) evaluating at least one output based on the Model; and
(d) transmitting the output to the computing device of the User via the communication network.

14. The system of claim 13, wherein generating the Model further comprises selecting the Customized Parameter(s) to be determined from a Model Parameters Set based on at least one criterion comprising that the values of the Customized Parameter(s) for the group of Users have a variance that exceeds a threshold value.

15. The system of claim 13, wherein generating the Model further comprises selecting the Customized Parameter(s) to be determined from a Model Parameters Set based on at least one criterion comprising that the values of the Customized Parameter(s) for the User determined at different times have a variance that is less than a threshold value.

16. The system of claim 13, wherein generating the Model comprises performing the best fit optimization of the Analytic Model to Observables in the record of Historical Data, to determine values for the User of the Customized Parameter(s) comprising coefficients of the Analytic Model and thereby fully specifying the Analytic Model.

17. The system of claim 16, wherein generating the Model further comprises selecting the Analytic Model from an Analytic Model Class based on data indicative of personal characteristics or constraints of the User.

18. The system of claim 16, wherein the Analytic Model comprises a global function comprising the sum of a plurality of Analytic Models each of which is scaled by a Weighting Parameter associated with a different Goal within the Goal Set.

19. The system of claim 16, wherein generating the Model further comprises generating the Analytic Model from a preconfigured basis function.

20. The system of claim 19, wherein generating the Analytic Model from the preconfigured basis function is based on at least one criterion comprising that the determined value of the Customized Parameter(s) for the preconfigured basis function maximizes an absolute value of a correlation coefficient of the Model to the Observables in the record of Historical Data.

21. The system of claim 13, wherein generating the Model comprises determining values of path coefficients of a Structural Equation Model (SEM) by determining values of correlation coefficients between linked Observables in the record of Historical Data, and thereby fully specifying the Structural Equation Model.

22. The system of claim 13, wherein the output comprises values of the Observables of the Historical Data predicted by the generated Model.

23. The system of claim 13, wherein the output comprises a Plan selected automatically by another filter function from a Plan Repository stored in the database.

24. The system of claim 13, wherein the output comprises a classification of one of the Observables in the record of Historical Data for the User as either beneficial or detrimental to the User achieving the Goal Set.
